(19) United States
(12) Patent Application Publication
(10) Pub. No.: US 2006/0210174 A1
(43) Pub. Date: Sep. 21, 2006

(54) System and method for transforming graphics data

(76) Inventor: Peter Thomas Bevan, West Perth (AU)

Correspondence Address: Robert E. Krebs, Thelen Reid & Priest LLP, P.O. Box 640640, San Jose, CA, 95164-0640, US

(21) Appl. No.: 11/083,806

(22) Filed: Mar. 18, 2005

(30) Foreign Application Priority Data
Mar. 18, 2005 (AU) 2004901429

(51) Int. Cl. G06K 9/36

(52) U.S. Cl. 382/232

(57) ABSTRACT

A system 10 for transforming graphics data comprising graphics data 12; and a transformation processor 14 for creating transformed graphics data 24, where the graphics data 12 and transformed graphics data 24 each comprise a set of frames 16, 26, each frame 18, 26 in the set of frames comprising a temporal locality and an array 18, 28 of graphics information 20, 30, the array 18, 28 having at least two dimensions and the graphics information 20, 30 having a set of attributes; and where the transformation processor 14 creates each frame 26 of the transformed graphics data 24 by dividing the frame 16 of graphics data 12 having a corresponding temporal locality into segments 36; dividing the frame 26 of transformed graphics data 24 into mapping segments 40, such that each mapping segment 40 has at least one corresponding segment 36; and, for each segment 36, deriving at least one attribute from the set of attributes of at least one graphics information 20 within the segment 36 and including the derived at least one attribute in the set of attributes for each graphics information 30 in its corresponding mapping segment 40, and where the segments 36 formed by dividing the frame 16 of graphics data 12 into segments 36 differ between frames 16 having adjacent temporal localities.

### FIELD OF THE INVENTION

The present invention is directed towards a system and method for transforming graphics data. The invention is particularly suited to producing a compressed set of graphics data from an original set of graphics data, the compressed set having limited loss of image quality in comparison to the original set. The invention may also be adapted for use in data-streaming applications.

### BACKGROUND ART

The following discussion of the background of the invention is intended to facilitate an understanding of the invention. However, it should be appreciated that the discussion is not an acknowledgment or admission that any of the material referred to was published, known or part of the common general knowledge of the person skilled in the art in any jurisdiction as at the priority date of the application.

The transmission of video images requires significant bandwidth to transmit the large amount of data needed to represent the video image. Yet, for some applications where video images could be provided, the bandwidth available is insufficient to allow satisfactory transmission of video images, or is such that the number of video images able to be transmitted is severely limited.

One method for reducing the problems mentioned in the previous paragraph has been to employ compression techniques. Compression of video images can occur on one of two levels:

at the data level; or

at the image level.

Compression at the data level typically involves the application of hash functions or other mathematical techniques to substitute repetitive patterns of data with a single reference. The benefits of such a technique is that the size of the data needed to represent the video images is reduced, but generally not at the expense of the quality of the video image.

The other alternative is compression at the image level. This involves seeking to change the display characteristics of the video image. One such technique is to reduce the size of the video image. While this often produces a video image of commercial quality and of reduced data size, the loss in size can also result in loss of detail. In certain situations, such as where the video image will be required to be analysed, this may not be a desirable effect.

Alternative techniques include eliminating or reducing colour levels and other high frequency data. However, the use of such techniques can result in the quality of the video image falling below what is commonly considered to be a commercially acceptable standard.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the invention there is a system for transforming graphics data comprising:

graphics data; and

a transformation processor for creating transformed graphics data, where the graphics data and transformed graphics data each comprise a set of frames, each frame in the set of frames comprising a temporal locality and an array of graphics information, the array having at least two dimensions and the graphics information having a set of attributes; and where the transformation processor creates each frame of the transformed graphics data by:

dividing the frame of graphics data having a corresponding temporal locality into segments;
dividing the frame of transformed graphics data into mapping segments, such that each mapping segment has at least one corresponding segment; and
for each segment, deriving at least one attribute from the set of attributes of at least one graphics information within the segment and including the derived at least one attribute in the set of attributes for each graphics information in its corresponding mapping segment,
   and where the segments formed by dividing the frame of graphics data into segments differ between frames having adjacent temporal localities.

Preferably, each segment comprises a group of graphics elements having substantially similar first and second spatial localities within the array.

Preferably, the transformation processor divides the frame of graphics data into segments with reference to a reference point.

More preferably, the reference point changes from frame to frame in accordance with a first defined oscillation sequence.

Preferably, the transformation processor divides the frame of graphics data into segments with reference to a set of segment co-ordinates.

More preferably, each set of segment co-ordinates changes from frame to frame in accordance with a first defined oscillation sequence.

Preferably, the transformation processor creates each frame of the transformed graphics data by:
dividing the frame of graphics data having a corresponding temporal locality into a series of planar arrays, each planar array representative of at least one attribute from the set of attributes;
dividing each planar array into segments;
dividing the frame of transformed graphics data into mapping segments, such that each mapping segment has at least one corresponding segment from each planar array; and
for each segment in each planar array, deriving the at least one attribute represented by the planar array from at least one graphics information within the segment and including the derived at least one attribute in the set of attributes for each graphics information in the corresponding mapping segment for the planar array being processed,
   and where the segments formed by dividing the planar arrays of graphics data into segments differ between frames having adjacent temporal localities and differ between at least two of the planar arrays.

More preferably, the transformation processor divides each planar array into segments with reference to a set of reference points, each reference point in the set of reference points associated with a planar array.

Still more preferably, each reference point in the set of reference points changes from frame to frame in accordance with a first defined oscillation sequence.

More preferably, the transformation process divides the planar arrays into segments with reference to a set of segment co-ordinates associated with the planar array, each segment co-ordinate in the set of segment co-ordinates associated with a planar array.

Still more preferably, each set of segment co-ordinates changes from frame to frame in accordance with first a defined oscillation sequence.

Ideally, the first defined oscillation sequence repeats after a predetermined number of iterations.

In a first alternative, the first defined oscillation sequence is a function of the temporal locality.

In a second alternative, the first defined oscillation sequence is a function of time as recorded by a time-measuring device.

In a third alternative, the first defined oscillation sequence is a function of sequence pulses emitted by a sequencer.

In a fourth alternative, the first defined oscillation sequence is a function of a pseudo-random generator.

In a fifth alternative, the first defined oscillation sequence is a modulation function.

Ideally, the difference in distance between reference points between frames having adjacent temporal localities is a single graphics information.

Preferably, the orientation of reference points between fames having adjacent temporal localities is determined at random.

Preferably, the at least one attribute is determined with reference to the position of the graphics information within the segment.

Preferably, the at least one attribute is derived by averaging the corresponding attribute values of at least two graphics information within the segment.

Preferably, any segment having less than a predetermined number of graphics information is omitted by the transformation processor for the purposes of deriving the at least one attribute.

Preferably, in the abstract, each segment is an interlocking shape or a shape that, in combination with at least one other shape, creates an interlocking pattern.

More preferably, each segment is a quadrilateral.

Still more preferably, each segment is a square.

Yet still more preferably, each segment has a side of length two graphics information.

Alternatively, each segment has a side of length three graphics information.

Preferably, the array of each frame of the transformed graphics data has a smaller number of graphics information than the array of each frame of the graphics data.

Preferably, the size of each segment of the transformed graphics data is a single graphics information.

Preferably, the system further includes a receiving terminal, the receiving terminal operable to display each frame of the transformed graphics data moved in accordance with a second defined oscillation sequence.

More preferably, the receiving terminal operates to display each frame multiple times.

More preferably, the receiving terminal displays frames in a predetermined alternating sequence.

In a first alternative, the second defined oscillation sequence repeats after a predetermined number of iterations.

In a second alternative, the second defined oscillation sequence is a function of the temporal locality.

In a third alternative, the second defined oscillation sequence is a function of time as recorded by a time-measuring device.

In a fourth alternative, the second defined oscillation sequence is a function of sequence pulses emitted by a sequencer.

In a fifth alternative, the second defined oscillation sequence is a function of a pseudo-random generator.

In a sixth alternative, the second defined oscillation sequence is a modulation function.

Preferably, at least one attribute from the set of attributes for each graphics information in the transformed graphics data is directly derived from the corresponding at least one attribute from the set of attributes for each graphics information in the graphics data.

Preferably, the graphics information is any base component, or representation of a base component, that can be used to display an image.

More preferably, the graphics information is a pixel.

Preferably, each array has three dimensions.

Preferably, the set of attributes includes a red colour intensity value, a green colour intensity value and a blue colour intensity value.

Alternatively, the set of attributes includes a hue value, a saturation value and a brightness value.

Alternatively, the set of attributes includes a luminance value, a B-Y colour difference value and a R-Y colour difference value.

Preferably, the system further includes a digitiser, the digitiser operable to create a set of graphics data from a set of analogue images.

Preferably, the transformation processor adapts the transformed graphics data to include interlacing techniques.

In accordance with a second aspect of the invention there is a transformation processor for use in a system for transforming graphics data into transformed graphics data, the graphics data and transformed graphics data each comprising a set of frames, each frame in the set of frames comprising a temporal locality and an array of graphics information, the array having at least two dimensions and the graphics information having a set of attributes, where the transformation processor creates each frame of the transformed graphics data by:
dividing the frame of graphics data having a corresponding temporal locality into segments;
dividing the frame of transformed graphics data into mapping segments, such that each mapping segment has at least one corresponding segment; and
for each segment, deriving at least one attribute from the set of attributes of at least one graphics information within the segment and including the derived at least one attribute in the set of attributes for each graphics information in its corresponding mapping segment,
   and where the segments formed by dividing the frame of graphics data into segments differ between frames having adjacent temporal localities.

Preferably, the transformation processor is operable to divide the frame of graphics data having a corresponding temporal locality into segments, each segment comprising a group of graphics information having substantially similar first and second spatial localities within the array.

Preferably, the transformation processor is further operable to divide the frame of graphics data into segments with reference to a reference point.

More preferably, the transformation processor redetermines the position of the reference point from frame to frame in accordance with a first defined oscillation sequence.

Preferably, the transformation processor divides the frame of graphics data into segments with reference to a set of segment co-ordinates.

Preferably, the transformation processor is operable to redetermine each segment co-ordinate in the set of segment co-ordinates from frame to frame in accordance with a first defined oscillation sequence.

Preferably, the transformation processor creates each frame of the transformed graphics data by:
dividing the frame of graphics data having a corresponding temporal locality into a series of planar arrays, each planar array representative of at least one attribute from the set of attributes;
dividing each planar array into segments;
dividing the frame of transformed graphics data into mapping segments, such that each mapping segment has at least one corresponding segment from each planar array; and
for each segment in each planar array, deriving the at least one attribute represented by the planar array from at least one graphics information within the segment and including the derived at least one attribute in the set of attributes for each graphics information in the corresponding mapping segment for the planar array being processed,
   and where the segments formed by dividing the planar arrays of graphics data into segments differ between frames having adjacent temporal localities and differ between at least two of the planar arrays.

More preferably, the transformation processor is operable to divide each planar array into segments with reference to a set of reference points, each reference point in the set of reference points associated with a planar array.

Still more preferably, the transformation processor is operable to redetermine the position of each reference point in the set of reference points from frame to frame in accordance with a first defined oscillation sequence.

Preferably, the transformation processor divides the planar arrays into segments with reference to a set of segment co-ordinates associated with the planar array, each segment co-ordinate in the set of segment co-ordinates associated with a planar array.

More preferably, the transformation processor is operable to redetermine each segment co-ordinate in the set of segment co-ordinates associated with each planar array from frame to frame in accordance with a first defined oscillation sequence.

Ideally, the first defined oscillation sequence repeats after a predetermined number of iterations.

As a first alternative, the first defined oscillation sequence is a function of the temporal locality.

As a second alternative, the first defined oscillation sequence is a function of time as recorded by a time-measuring device.

As a third alternative, the first defined oscillation sequence is a function of sequence pulses emitted by a sequencer.

As a fourth alternative, the first defined oscillation sequence is a function of a pseudo-random generator.

As a fifth alternative, the first defined oscillation sequence is a modulation function.

Preferably, the difference in distance between reference points between frames having adjacent temporal localities is a single graphics information.

Preferably, the transformation processor is operable to determine the orientation of reference points between frames having adjacent temporal localities at random.

Preferably, the transformation processor is operable to derive the at least one attribute with reference to the position of the graphics information with the segment.

Preferably, the transformation processor derives the at least one attribute by averaging the corresponding attribute values of at least two graphics information within the segment.

Preferably, the transformation processor omits any segment having less than a predetermined number of graphics information for the purposes of deriving the at least one attribute.

In accordance with a third aspect of the present invention there is a receiving terminal for use in a system for transforming graphics data, the receiving terminal operable to receive transformed graphics data created by a transformation processor as described as the second aspect of the present invention, the receiving terminal operable to display each frame of the transformed graphics data moved in accordance with a second defined oscillation sequence.

Preferably, the receiving terminal is operable to display each frame multiple times.

Preferably, the receiving terminal displays frames in a predetermined alternating sequence.

Ideally, the second defined oscillation sequence repeats after a predetermined number of iterations.

In a first alternative, the second defined oscillation sequence is a function of the temporal locality.

In a second alternative, the second defined oscillation sequence is a function of time as recorded by a time-measuring device.

In a third alternative, the second defined oscillation sequence is a function of sequence pulses emitted by a sequencer.

In a fourth alternative, the second defined oscillation sequence is a function of a pseudo-random generator.

In a fifth alternative, the second defined oscillation sequence is a modulation function.

In accordance with a fourth aspect of the invention, there is a method of transforming graphics data into transformed graphics data, where the graphics data and transformed graphics data each comprise a set of frames, each frame in the set of frames comprising a temporal locality and an array of graphics information, the array having at least two dimensions and the graphics information having a set of attributes, where each frame of the transformed graphics data is created by the following method:
dividing the frame of graphics data having a corresponding temporal locality into segments, such that the segments so formed differ between frames having adjacent temporal localities;
dividing the frame of transformed graphics data into mapping segments, such that each mapping segment has at least one corresponding segment; and
for each segment, deriving at least one attribute from the set of attributes of at least one graphics information within the segment and including the derived at least one attribute in the set of attributes for each graphics information in its corresponding mapping segment.

Preferably, the step of dividing the frame of graphics data into segments is achieved with reference to a reference point.

More preferably, the method includes the step of redetermining the reference point from frame to frame in accordance with a first defined oscillation sequence.

Alternatively, the step of dividing the frame of graphics data into segments is achieved with reference to a set of segment co-ordinates.

More preferably, the method includes the step of redetermining each segment co-ordinate in the set of segment co-ordinates in accordance with a first defined oscillation sequence.

In accordance with a fifth aspect of the present invention there is a method of transforming graphics data into transformed graphics data, where the graphics data and transformed graphics data each comprise a set of frames, each frame in the set of frames comprising a temporal locality and an array of graphics information, the array having at least two dimensions and the graphics information having a set of attributes, where each frame of the transformed graphics data is created by the following method:
dividing the frame of graphics data having a corresponding temporal locality into a series of planar arrays, each planar array representative of at least one attribute from the set of attributes;
dividing each planar array into segments, such that the segments so formed differ between corresponding planar arrays of frames having adjacent temporal localities and differ between at least two of the planar arrays;
dividing the frame of transformed graphics data into mapping segments, such that each mapping segment has at least one corresponding segment from each planar array; and
for each segment in each planar array, deriving the at least one attribute represented by the planar array from at least one graphics information within the segment and including the derived at least one attribute in the set of attributes for each graphics information in the corresponding mapping segment for the planar array being processed.

Preferably, the step of dividing each planar array into segments is achieved with reference to a set of reference points, each reference point in the set of reference points associated with a planar array.

More preferably, the method includes the step of redetermining each reference point in the set of reference points in accordance with a first defined oscillation sequence.

Alternatively, the step of dividing each planar array into segments is achieved with reference to a set of segment co-ordinates, each set of segment co-ordinates in the set of segment co-ordinates associated with a planar array.

More preferably, the method includes the step of redetermining each segment co-ordinate in the set of segment co-ordinates in accordance with a first defined oscillation sequence.

Preferably, the first defined oscillation sequence repeats after a predetermined number of iterations.

In a first implementation, the first defined oscillation sequence is a function of time as recorded by a time-measuring device.

In a second implementation, the first defined oscillation sequence is a function of sequence pulses emitted by a sequencer.

In a third implementation, the first defined oscillation sequence is a function of a pseudo-random generator.

In a fourth implementation, the first defined oscillation sequence is a modulation function.

Alternatively, the method includes the step of redetermining the orientation of the reference point for the next frame at random.

Preferably, the step of deriving the at least one attribute is determined with reference to the position of the graphics information within the segment.

Alternatively, the step of deriving the at least one attribute is determined by averaging the corresponding attribute values of at least two graphics information within the segment.

Preferably, the method includes the step of omitting any segment having less than a predetermined number of graphics for the purposes of deriving the at least one attribute.

Preferably, the method includes the step of displaying each frame of the transformed graphics data moved in accordance with a second defined oscillation sequence at a receiving terminal in receipt of the transformed graphics data.

More preferably, the step of displaying each frame is repeated a predetermined number of times.

Still more preferably, the step of displaying each frame is performed with reference to a predetermined alternating sequence.

In a first arrangement, the second defined oscillation sequence repeats after a predetermined number of iterations.

In a second arrangement, the second defined oscillation sequence is a function of the temporal locality.

In a third arrangement, the second defined oscillation sequence is a function of time as recorded by a time-measuring device.

In a fourth arrangement, the second defined oscillation sequence is a function of sequence pulses emitted by a sequencer.

In a fifth arrangement, the second defined oscillation sequence is a function of a pseudo-random generator.

In a sixth arrangement, the second defined oscillation sequence is a modulation function.

Preferably, the method includes the step of directly deriving at least one attribute from the set of attributes for each graphics information in the transformed graphics data from the corresponding at least one attribute from the set of attributes for each graphics information in the graphics data.

Preferably, the method includes the step of digitising a set of analogue images to create the graphics data.

Preferably, the method includes the step of applying interlacing techniques to the transformed graphics data.

In accordance with a sixth aspect of the invention there is a computer-readable medium having software recorded thereon for transforming graphics data into transformed graphics data, the graphics data and transformed graphics data each comprising a set of frames, each frame in the set of frames comprising a temporal locality and an array of graphics information, the array having at least two dimensions and the graphics information having a set of attributes, the software including:
means for dividing a frame of graphics data into segments, such that the segments so formed differ between frames having adjacent temporal localities;
means for dividing a frame of transformed graphics data having a corresponding temporal locality into mapping segments, such that each mapping segment has at least one corresponding segment; and
means for deriving at least one attribute from the set of attributes for at least one graphics information within each segment and including the derived at least one attribute in the set of attributes for each graphics information in its corresponding mapping segment.

In accordance with a seventh aspect of the invention there is transformed graphics data derived from graphics data, where the graphics data and transformed graphics data each comprise a set of frames, each frame in the set of frames comprising a temporal locality and an array of graphics information, the array having at least two dimensions and the graphics information having a set of attributes, each frame of the transformed graphics data having been created by the following method:
dividing the frame of graphics data having a corresponding temporal locality into segments, such that the segments so formed differ between frames having adjacent temporal localities;
dividing the frame of transformed graphics data into mapping segments, such that each mapping segment has at least one corresponding segment; and
for each segment, deriving at least one attribute from the set of attributes of at least one graphics information within the segment and including the derived at least one attribute in the set of attributes for each graphics information in its corresponding mapping segment.

In accordance with an eight aspect of the invention there is transformed graphics data derived from graphics data, where the graphics data and transformed graphics data each comprise a set of frames, each frame in the set of frames comprising a temporal locality and an array of graphics information, the array having at least two dimensions and the graphics information having a set of attributes, each frame of the transformed graphics data having been created by the following method:
dividing the frame of graphics data having a corresponding temporal locality into a series of planar arrays, each planar array representative of at least one attribute from the set of attributes;
dividing each planar array into segments, such that the segments so formed differ between corresponding planar arrays of frames having adjacent temporal localities and differ between at least two of the planar arrays;
dividing the frame of transformed graphics data into mapping segments, such that each mapping segment has at least one corresponding segment from each planar array; and
   for each segment in each planar array, deriving the at least one attribute represented by the planar array from at least one graphics information within the segment and including the derived at least one attribute in the set of attributes for each graphics information in the corresponding mapping segment for the planar array being processed.

### BRIEF DESCRIPTION OF THE DRAWINGS

The invention will be described with reference to the following drawings, of which:

FIG. 1 is an abstract representation of a first iteration of a mapping process of a first embodiment of the invention.

FIG. 2 is an abstract representation of a second iteration of the mapping process of the first embodiment of the invention shown in FIG. 1.

FIG. 3 is an abstract representation of a third iteration of the mapping process of the first embodiment of the invention shown in FIG. 1.

FIG. 4 is an abstract representation of a fourth iteration of the mapping process of the first embodiment of the invention shown in FIG. 1.

FIG. 5 is an abstract representation of a fifth iteration of a mapping process of the first embodiment of the invention shown in FIG. 1.

FIG. 6 is an abstract representation of a first iteration of a mapping process of a second embodiment of the invention.

FIG. 7 is an abstract representation of a second iteration of the mapping process of the second embodiment of the invention shown in FIG. 6.

FIG. 8 is an abstract representation of a third iteration of the mapping process of the second embodiment of the invention shown in FIG. 6.

FIG. 9 is an abstract representation of a fourth iteration of the mapping process of the second embodiment of the invention shown in FIG. 6.

FIG. 10 is an abstract representation of a fifth iteration of a mapping process of the second embodiment of the invention shown in FIG. 6.

FIG. 11 is an abstract representation of a first iteration of a mapping process of a third embodiment of the invention.

FIG. 12 is an abstract representation of a second iteration of the mapping process of the third embodiment of the invention shown in FIG. 11.

FIG. 13 is an abstract representation of a third iteration of the mapping process of the third embodiment of the invention shown in FIG. 11.

FIG. 14 is an abstract representation of a fourth iteration of the mapping process of the third embodiment of the invention shown in FIG. 11.

FIG. 15 is an abstract representation of a fifth iteration of a mapping process of the third embodiment of the invention shown in FIG. 11.

FIG. 16 is an abstract representation of a first iteration of a mapping process of a fourth embodiment of the invention.

FIG. 17 is an abstract representation of a second iteration of the mapping process of the fourth embodiment of the invention shown in FIG. 16.

FIG. 18 is an abstract representation of a third iteration of the mapping process of the fourth embodiment of the invention shown in FIG. 16.

FIG. 19 is an abstract representation of a fourth iteration of the mapping process of the fourth embodiment of the invention shown in FIG. 16.

FIG. 20 is an abstract representation of a fifth iteration of a mapping process of the fourth embodiment of the invention shown in FIG. 16.

FIG. 21 is an abstract representation of a first iteration of a mapping process of a fifth embodiment of the invention.

FIG. 22 is an abstract representation of a second iteration of the mapping process of the fifth embodiment of the invention shown in FIG. 21.

FIG. 23 is an abstract representation of a third iteration of the mapping process of the fifth embodiment of the invention shown in FIG. 21.

FIG. 24 is an abstract representation of a fourth iteration of the mapping process of the fifth embodiment of the invention shown in FIG. 21.

FIG. 25 is an abstract representation of a fifth iteration of a mapping process of the fifth embodiment of the invention shown in FIG. 21.

### BEST MODE(S) FOR CARRYING OUT THE INVENTION

In accordance with a first embodiment of the invention there is a system for transforming graphics data 10 comprising:

graphics data 12; and

a transformation processor 14.

The graphics data 12 comprises a set of frames 16. Frames 16 have a temporal locality, hereafter referred to as a sequence value, to indicate the order in which the set of frames 16 should be displayed. Each frame 16 comprises a two-dimensional array 18 of graphics information 20.

Each graphics information 20 has two spatial localities, referred to hereafter as its x location and its y location respectively. The x and y values also represent the location of the graphics information 20 within the array 18.

In this embodiment, the graphics information 20 takes the form of a pixel 22. Each pixel 22 has a set of colour attributes. For the purposes of the following example, the set of colour attributes includes:

a red colour intensity value for the pixel 22;

a green colour intensity value for the pixel 22; and

a blue colour intensity value for the pixel 22.

In its totality, the graphics data 12 shows a video image. As the means by which a video image can be displayed using a set of frames 16 and a sequence value will be known to the person skilled in the art, it will not be described in more detail here.

The transformation processor 14 manipulates the graphics data 12 to form transformed graphics data 24. The transformed graphics data 24 comprises a set of frames 26. Like the frames 16 of graphics data 12, frames 26 have a sequence value to indicate the order in which the set of frames 26 should be displayed. Each frame 26 comprises a two dimensional array 28 of graphics information 30.

As above, in this embodiment the graphics information 30 takes the form of pixels 32. The pixels 32 have the same characteristics as pixels 22.

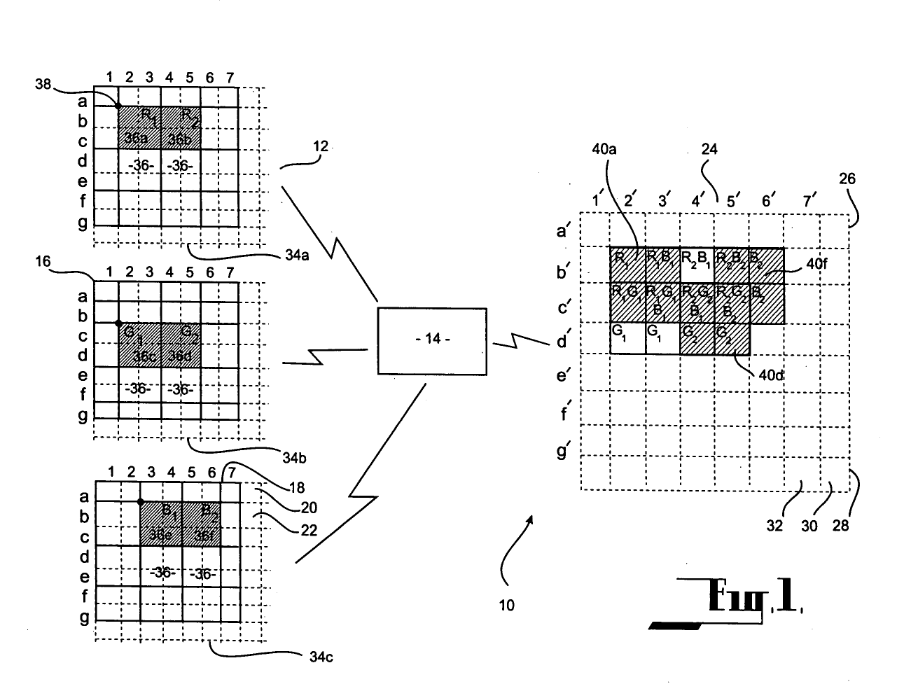

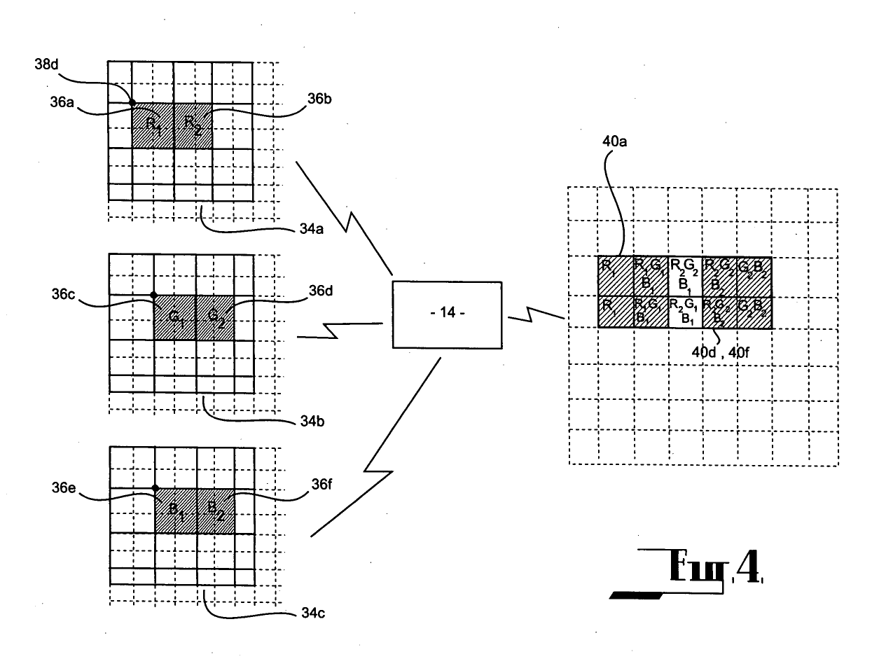

The process by which the transformation processor 14 manipulates the graphics data 12 to form transformed graphics data 24 is described below with reference to the schematics depicted in FIGS. 1 to 5. It should be noted that the schematics shown in FIGS. 1 to 5 are abstractions, as graphics data 12 will commonly be embodied by a disk or electronic memory or other computer readable storage device.

By way of initial description FIGS. 1 to 5 each depict a frame 16 from the set of graphics data 12 and its corresponding frame 26 in the transformed set of graphics data 24 (as determined by their sequence values). The frame is divided into three separate planar arrays 34. Each planar array 34 represents a colour intensity value for the pixels 22 of the frame 16. As a result:

planar array 34a is representative of the red colour intensity value for each pixel 22 of the frame 16;

planar array 34b is representative of the green colour intensity value for each pixel 22 of the frame 16; and

planar array 34c is representative of the blue colour intensity value for each pixel 22 of the frame 16.

Each planar array 34 is equal in size to array 18. While each value in a planar array 34 is technically a colour intensity value for a pixel 22, for ease of reference and understanding, throughout this specification, such values, when described within the context of a planar array 34, will be referred to as pixels 22.

The y values of each pixel 22 in the planar arrays 34 shown in FIG. 1 are labelled by the values a to g. The x values of each pixel 22 in the planar arrays 34 shown in FIG. 1 are labelled by the values 1 to 7. Corresponding references are used in relation to each frame 26 from the set of transformed graphics data, but distinguished by use of the ′ symbol.

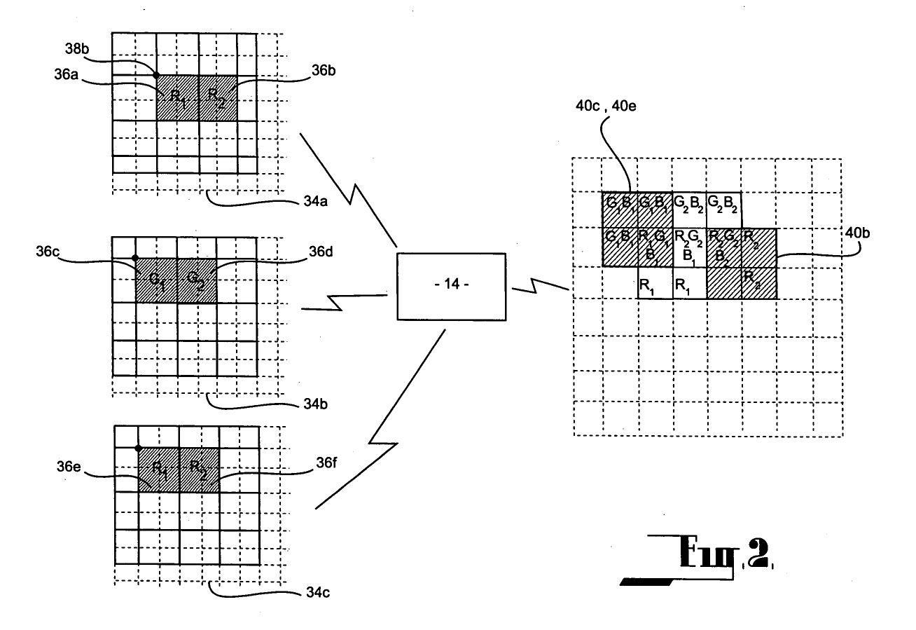

While not depicted in FIGS. 2 to 4, the x and y values for each planar array 34 will be referred to using the same label references as shown in FIG. 1.

This embodiment of the system 10 will now be described.

As shown in FIG. 1, each planar array 34 of the frame 16 of the graphics data 12 is divided into segments 36. Segments 36 are illustrated in FIGS. 1 to 5 as bound by a solid line while the pixels 22 within each segment 36 are bound by dotted lines, except where the boundary of the pixel 22 intersects with the boundary of a segment 36.

The method of dividing each planar array 34 into segments 36 will now be described in the context of planar array 34a. Segments 36 are created by dividing the planar array 34a into a series of pixel “squares”. In this embodiment, the side of each segment 36 “square” has a length of two pixels. This division commences from a predetermined first reference point 38a. This means that the segments 36 at the boundaries of the planar array 34a may have a lesser number of pixels 22 therein, and potentially vary in shape, as a result of the number of pixels 22 in either the x or y dimension of the planar array 34a not being evenly divisible by the length of the side of each segment 36 “square”. This may also occur in situations where the number of pixels 22 in either the x or y dimension of the planar array 34a are evenly divisibly by the length of the side of segment 36 “square”, but the position of the predetermined first reference point 38a does not allow for equal division of the planar array 34a.

The same method used to divide planar array 34a into segments 36, as described in the last paragraph, is used to divide planar arrays 34b, 34c into segments 36. It should be noted though that the predetermined first reference point 38a differs from one planar array 34 to the next.

Focus will now be placed on the six highlighted segments 36 shown in FIG. 1. Segments 36a, 36b are segments within planar array 34a. Segments 36c, 36d are segments within planar array 34b. Segments 36e, 36f are segments within planar array 34c.

For the first segment 36a shown, the segment 36a includes pixels 22 having (x, y) values within planar array 34a as follows: {(b,2), (b,3), (c,2), (c,3)}. For the second segment 36b, the segment 36b includes pixels 22 having (x, y) values as follows: {(b,4), (b,5), (c,4), (c,5)}.

For the third segment 36c shown, the segment 36c includes pixels 22 having (x, y) values within planar array 34b as follows: {(c,2), (c,3), (d,2), (d,3)}. For the fourth segment 36d, the segment 36d includes pixels 22 having (x, y) values as follows: {(c,4), (c,5), (d,4), (d,5)}.

For the fifth segment 36e shown, the segment 36e includes pixels 22 having (x, y) values within planar array 34c as follows: {(b,3), (b,4), (c,3), (c,4)}. For the sixth segment 36f, the segment 36f includes pixels 22 having (x, y) values as follows: {(b,5), (b,6), (c,5), (c,6)}.

The pixels 22 forming the first segment 36a are mapped to a corresponding segment 40a in frame 28. Segment 40a is easily determined as the pixels 32 within segment 40a each have a corresponding (x, y) value to a pixel 22 in segment 36a.

However, this mapping is limited to the red colour intensity value of each pixel 32 within segment 40a. To elaborate, the red colour intensity value of each pixel 32 within segment 40a is inherited from the pixel 22 within segment 36a holding a predetermined position (ie. In abstraction terms, the upper left position, lower right position, etc.).

The pixels 22 forming the second segment 36b are mapped to pixels 32 within corresponding frame 40b in the same manner as described in the last two paragraphs.

The pixels 22 forming the third segment 36c are mapped to a corresponding segment 40c in frame 28. Segment 40c is easily determined as the pixels 32 within segment 40c each have a corresponding (x, y) value to a pixel 22 in segment 36c.

However, this mapping is limited to the green colour intensity value of each pixel 32 within segment 40c. To elaborate, the green colour intensity value of each pixel 32 within segment 40c is inherited from the pixel 22 within segment 36c holding a predetermined position (ie. In abstraction terms, the upper left position, lower right position, etc.).

The pixels 22 forming the fourth segment 36d are mapped to pixels 32 within corresponding frame 40d in the same manner as described in the last two paragraphs.

The pixels 22 forming the fifth segment 36e are mapped to a corresponding segment 40e in frame 28. Segment 40e is easily determined as the pixels 32 within segment 40e each have a corresponding (x, y) value to a pixel 22 in segment 36e.

However, this mapping is limited to the blue colour intensity value of each pixel 32 within segment 40e. To elaborate, the blue colour intensity value of each pixel 32 within segment 40e is inherited from the pixel 22 within segment 36e holding a predetermined position (ie. In abstraction terms, the upper left position, lower right position, etc.).

The pixels 22 forming the sixth segment 36f are mapped to pixels 32 within corresponding frame 40f in the same manner as described in the last two paragraphs.

As a result of this mapping, the colour intensity values for pixels 32 can be clearly shown with reference to the following table.

| | |
|---|---|
| (b′, 2′) | the red colour intensity value of the pixel 22 within segment |
| | 36a holding the predetermined position for segment 36a. |
| (b′, 3′) | the red colour intensity value of the pixel 22 within segment |
| | 36a holding the predetermined position for segment 36a. |
| | the blue colour intensity value of the pixel 22 within segment |
| | 36e holding the predetermined position for segment 36e. |
| (b′, 4′) | the red colour intensity value of the pixel 22 within segment |
| | 36b holding the predetermined position for segment 36b. |
| | the blue colour intensity value of the pixel 22 within segment |
| | 36e holding the predetermined position for segment 36e. |
| (b′, 5′) | the red colour intensity value of the pixel 22 within segment |
| | 36b holding the predetermined position for segment 36b. |
| | the blue colour intensity value of the pixel 22 within segment |
| | 36f holding the predetermined position for segment 36f. |
| (b′, 6′) | the blue colour intensity value of the pixel 22 within segment |
| | 36f holding the predetermined position for segment 36f. |
| (c′, 2′) | the red colour intensity value of the pixel 22 within segment |
| | 36a holding the predetermined position for segment 36a. |
| | the green colour intensity value of the pixel 22 within segment |
| | 36c holding the predetermined position for segment 36c. |
| (c′, 3′) | the red colour intensity value of the pixel 22 within segment |
| | 36a holding the predetermined position for segment 36a. |
| | the green colour intensity value of the pixel 22 within segment |
| | 36c holding the predetermined position for segment 36c. |
| | the blue colour intensity value of the pixel 22 within segment |
| | 36e holding the predetermined position for segment 36e. |
| (c′, 4′) | the red colour intensity value of the pixel 22 within segment |
| | 36b holding the predetermined position for segment 36b. |
| | the green colour intensity value of the pixel 22 within segment |
| | 36d holding the predetermined position for segment 36d. |
| | the blue colour intensity value of the pixel 22 within segment |
| | 36e holding the predetermined position for segment 36e. |
| (c′, 5′) | the red colour intensity value of the pixel 22 within segment |
| | 36b holding the predetermined position for segment 36b. |
| | the green colour intensity value of the pixel 22 within segment |
| | 36d holding the predetermined position for segment 36d. |
| | the blue colour intensity value of the pixel 22 within segment |
| | 36f holding the predetermined position for segment 36f. |
| (c′, 6′) | the blue colour intensity value of the pixel 22 within segment |
| | 36f holding the predetermined position for segment 36f. |
| (d′, 2′) | the green colour intensity value of the pixel 22 within segment |
| | 36c holding the predetermined position for segment 36c. |
| (d′, 3′) | the green colour intensity value of the pixel 22 within segment |
| | 36c holding the predetermined position for segment 36c. |
| (d′, 4′) | the green colour intensity value of the pixel 22 within segment |
| | 36d holding the predetermined position for segment 36d. |
| (d′, 5′) | the green colour intensity value of the pixel 22 within segment |
| | 36d holding the predetermined position for segment 36d. |

The predetermined first reference point 38a is then shifted in accordance with a defined oscillation sequence to form a second reference point 38b. A similar process is followed in respect of the other planar arrays, 34b, 34c so that new reference points 38 are established for each planar array 34 by way of defined oscillation sequences.

Turning to FIG. 2, segments 36 are created in the planar arrays 34 for the next frame 16 (as determined by the sequence value) in the same manner as described above but commencing from the second reference point 38b and the new reference points 38 established for each other planar array 34.

Again looking at the six highlighted segments, for the first segment 36a shown, the segment includes pixels 22 having (x, y) values within planar array 34a as follows: {(c,3), (c,4), (d,3), (d,4)}. For the second segment 36b, the segment 36b includes pixels 22 having (x, y) values as follows: {(c,5), (c,6), (d,5), (d,6)}.

For the third segment 36c shown, the segment 36c includes pixels 22 having (x, y) values within planar array 34b as follows: {(b,2), (b,3), (c,2), (c,3)}. For the fourth segment 36d, the segment 36d includes pixels 22 having (x, y) values as follows: {(b,4), (b,5), (c,4), (c,5)}.

For the fifth segment 36e shown, the segment 36e includes pixels 22 having (x, y) values within planar array 34c as follows: {(b,2), (b,3), (c,2), (c,3)}. For the sixth segment 36f, the segment 36f includes pixels 22 having (x, y) values as follows: {(b,4), (b,5), (c,4), (c,5)}.

The mapping process as described in respect of FIG. 1 is then repeated. As a result of this mapping, the colour intensity values for pixels 32 can be clearly shown with reference to the following table.

| | |
|---|---|
| (b′, 2′) | the green colour intensity value of the pixel 22 within segment |
| | 36c holding the predetermined position for segment 36c. |
| | the blue colour intensity value of the pixel 22 within segment |
| | 36e holding the predetermined position for segment 36e. |
| (b′, 3′) | the green colour intensity value of the pixel 22 within segment |
| | 36c holding the predetermined position for segment 36c. |
| | the blue colour intensity value of the pixel 22 within segment |
| | 36e holding the predetermined position for segment 36e. |
| (b′, 4′) | the green colour intensity value of the pixel 22 within segment |
| | 36d holding the predetermined position for segment 36d. |
| | the blue colour intensity value of the pixel 22 within segment |
| | 36f holding the predetermined position for segment 36f. |
| (b′, 5′) | the green colour intensity value of the pixel 22 within segment |
| | 36d holding the predetermined position for segment 36d. |
| | the blue colour intensity value of the pixel 22 within segment |
| | 36f holding the predetermined position for segment 36f. |
| (c′, 2′) | the green colour intensity value of the pixel 22 within segment |
| | 36c holding the predetermined position for segment 36c. |
| | the blue colour intensity value of the pixel 22 within segment |
| | 36e holding the predetermined position for segment 36e. |
| (c′, 3′) | the red colour intensity value of the pixel 22 within segment |
| | 36a holding the predetermined position for segment 36a. |
| | the green colour intensity value of the pixel 22 within segment |
| | 36c holding the predetermined position for segment 36c. |
| | the blue colour intensity value of the pixel 22 within segment |
| | 36e holding the predetermined position for segment 36e. |
| (c′, 4′) | the red colour intensity value of the pixel 22 within segment |
| | 36a holding the predetermined position for segment 36a. |
| | the green colour intensity value of the pixel 22 within segment |
| | 36d holding the predetermined position for segment 36d. |
| | the blue colour intensity value of the pixel 22 within segment |
| | 36f holding the predetermined position for segment 36f. |
| (c′, 5′) | the red colour intensity value of the pixel 22 within segment |
| | 36b holding the predetermined position for segment 36b. |
| | the green colour intensity value of the pixel 22 within segment |
| | 36d holding the predetermined position for segment 36d. |
| | the blue colour intensity value of the pixel 22 within segment |
| | 36f holding the predetermined position for segment 36f. |
| (c′, 6′) | the red colour intensity value of the pixel 22 within segment |
| | 36b holding the predetermined position for segment 36b. |
| (d′, 3′) | the red colour intensity value of the pixel 22 within segment |
| | 36a holding the predetermined position for segment 36a. |
| (d′, 4′) | the red colour intensity value of the pixel 22 within segment |
| | 36a holding the predetermined position for segment 36a. |
| (d′, 5′) | the red colour intensity value of the pixel 22 within segment |
| | 36b holding the predetermined position for segment 36b. |
| (d′, 6′) | the red colour intensity value of the pixel 22 within segment |
| | 36b holding the predetermined position for segment 36b. |

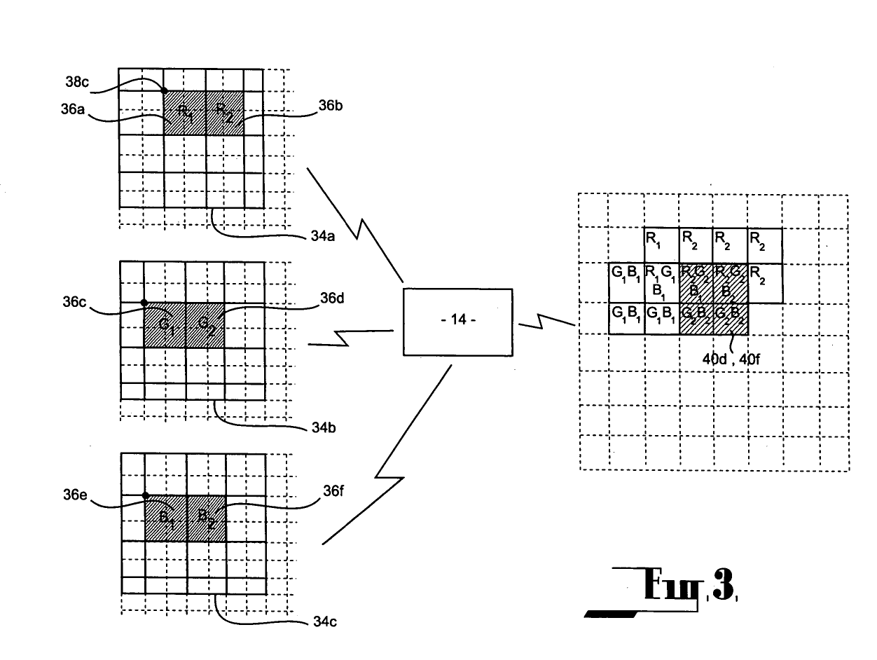

New reference points 38 are again recalculated using the defined oscillation sequences for each planar array 34 and the above process repeated. This is illustrated in FIGS. 3 to 5.

It should be noted that the end result of the described embodiment is that each pixel 32 in frame 26 obtains a red colour intensity value, a green colour intensity value and a blue colour intensity value.

In this manner, the use of oscillating planar arrays of graphics information as the basis for determining the transformed set of graphics data 24, when shown at an appropriate resolution and display rate, is operable to produce transformed graphics data 22 having little, if any, variation in visual appearance to the visual appearance of the displayed graphics data 12, as determined by a human eye. This is due to the fact that the movement of the transformed graphics data 22 masks the pixellisation.

Further, the amount of data needed to store or transmit the transformed graphics data 22 is significantly less than that needed to store or transmit the graphics data 12 as only one colour intensity value per segment 40 need be recorded, along with a means for determining the positions of each segment 40, rather than needing to store a multiple of colour intensity values for each pixel 22.

Providing further benefit to the invention is the fact that this method can be combined with other known data compression techniques to provide yet further reductions in the amount of data needed to store or transmit the transformed graphics data 22.

In accordance with a second embodiment of the invention, there is a system 200 for transforming graphics data comprising:

graphics data 202; and

a transformation processor 204.

The graphics data 202 comprises a set of frames 206. Frames 206 have a temporal locality, hereafter referred to as a sequence value, to indicate the order in which the set of frames 206 should be displayed. Each frame 206 comprises a two-dimensional array 208 of graphics information 210.

Each graphics information 210 has two spatial localities, referred to hereafter as its x location and its y location respectively. The x and y values also represent the location of the graphics information 210 within the array 208.

In this embodiment, the graphics information 210 takes the form of a pixel 212. Each pixel 212 has a set of colour attributes. For the purposes of the following example, the set of colour attributes includes:

a red colour intensity value for the pixel 212;

a green colour intensity value for the pixel 212; and

a blue colour intensity value for the pixel 212.

In its totality, the graphics data 202 shows a video image.

The transformation processor 204 manipulates the graphics data 202 to form transformed graphics data 214. The transformed graphics data 214 comprises a set of frames 216. Like the frames 206 of graphics data 202, frames 216 have a sequence value to indicate the order in which the set of frames 216 should be displayed. Each frame 216 comprises a two dimensional array 218 of graphics information 220.

As above, in this embodiment the graphics information 220 takes the form of pixels 222. The pixels 222 have the same characteristics as pixels 212.

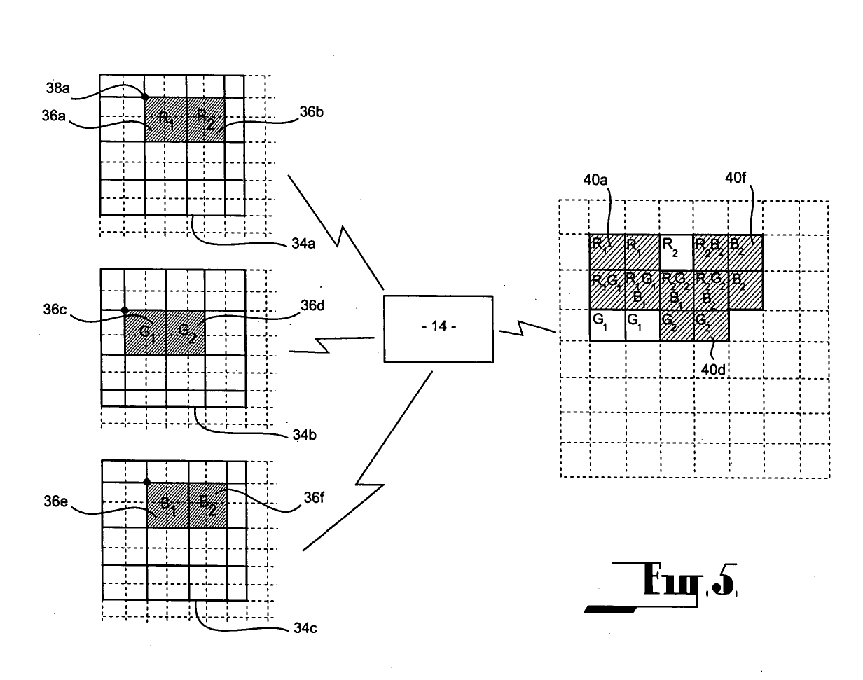

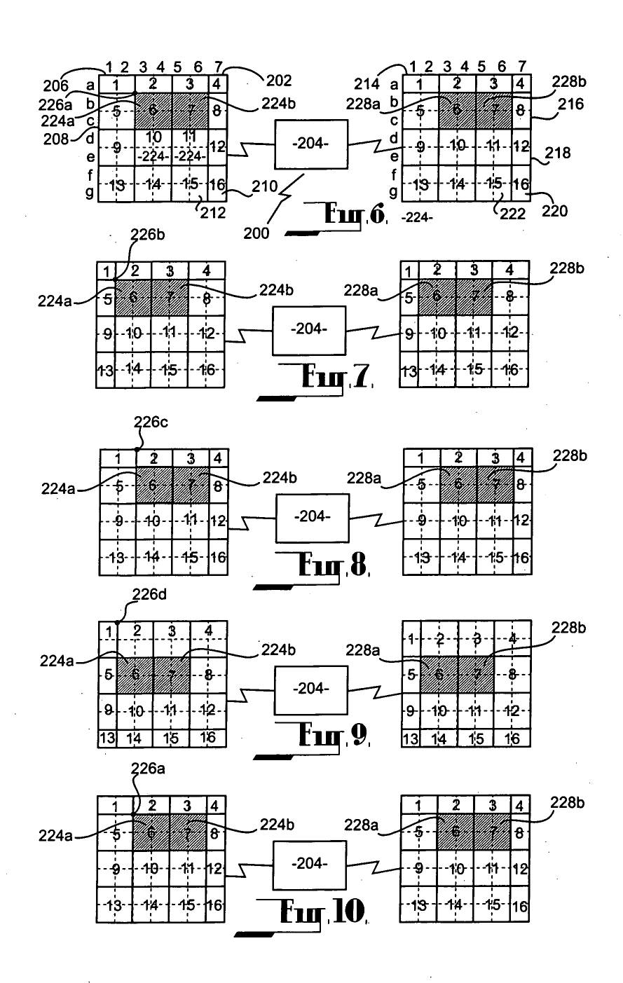

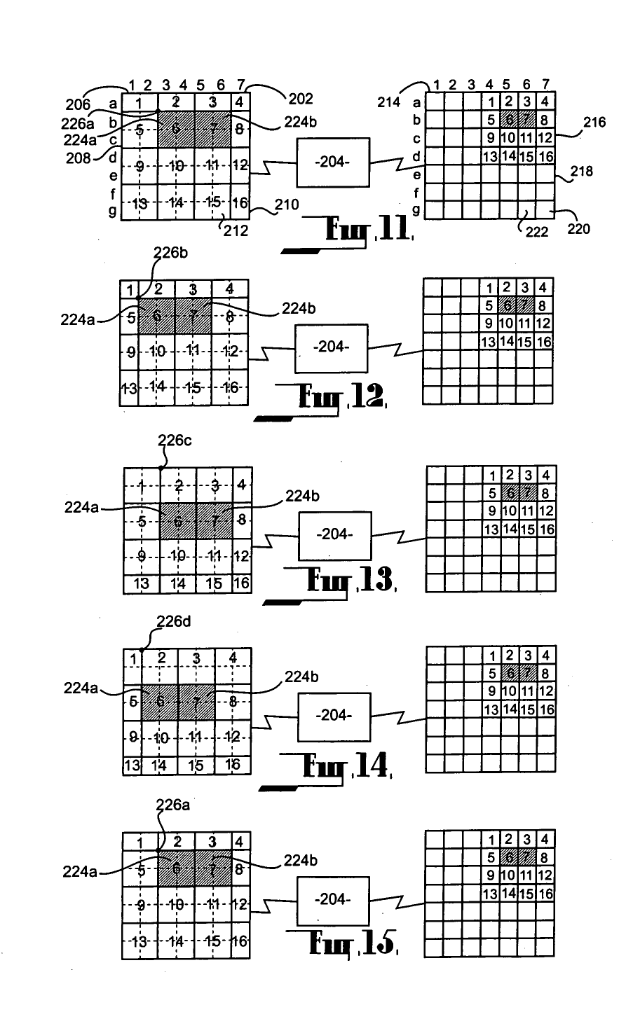

The process by which the transformation processor 204 manipulates the graphics data 202 to form transformed graphics data 214 is described below with reference to the schematics depicted in FIGS. 6 to 10. Again, FIGS. 6 to 10 are abstractions.

By way of initial description FIGS. 6 to 10 each depict a frame 206 from the set of graphics data 202 and its corresponding frame 216 in the transformed set of graphics data 214 (as determined by their sequence values). In this embodiment the frame 206 is not divided into planar arrays as described in the first embodiment. The reason for this will become clear in the description below.

The y values of each pixel 212 in the frame 206 shown in FIG. 6 are labelled by the values a to g. The x values of each pixel 212 in the frame 206 shown in FIG. 6 are labelled by the values 1 to 7. Corresponding references are used in relation to each frame 216 from the set of transformed graphics data 212, but distinguished by use of the ′ symbol.

While not depicted in FIGS. 7 to 10, the x and y values for each frame 206 will be referred to using the same label references as shown in FIG. 6.

This embodiment of the system 200 will now be described.

As shown in FIG. 6, each frame 206 is divided into segments 224. Segments 224 are illustrated in FIGS. 6 to 10 as bound by a solid line while the pixels 212 within each segment 224 are bound by dotted lines, except where the boundary of the pixel 212 intersects with the boundary of a segment 224.

Segments 224 are created by dividing the frame 206 into a series of pixel “squares”. This division commences from a predetermined first reference point 226a. This means that the segments 224 at the boundaries of the frame 206 may have a lesser number of pixels 212 therein, and potentially vary in shape, as a result of the number of pixels 212 in either the x or y dimension of the array 208 not being evenly divisible by the length of the side of each segment 224 “square”. This may also occur in situations where the number of pixels 212 in either the x or y dimension of the frame 206 is evenly divisible by the length of the side of segment 224 “square”, but the position of the predetermined first reference point 226a does not allow for equal division of the frame 206.

Focus will now be placed on the two highlighted segments 224 shown in FIG. 6. For the first segment 224a shown, the segment 224a includes pixels 212 having (x, y) values as follows: {(b,3), (b,4), (c,3), (c,4)}. For the second segment 224b, the segment 224b includes pixels 212 having (x, y) values as follows: {(b,5), (b,6), (c,5), (c,6)}.

The pixels 212 forming the first segment 224a are mapped to a corresponding segment 228a in frame 216. Segment 228a is easily determined as the pixels 222 within segment 228a each have a corresponding (x, y) value to a pixel 212 in segment 224a.

In addition to mapping segments 224 to segments 228, the set of colour attributes of the pixels 222 within segment 228 are derived from the set of colour attributes of the pixels 212 in the segment 224 from which it is derived. In this example, the set of colour attributes of the pixels 212 in mapped segment 228 are inherited from the pixel 212 within the segment 224 holding a predetermined position (ie. in abstraction terms, the upper left position, lower right position, etc.).

The predetermined first reference point 226a is then shifted in accordance with a defined oscillation sequence to form a second reference point 226b. The process of mapping segments 224 to segments 228 in the next frame (as determined by the sequence value) commences as described above with a third reference point 226c being determined at the end of the mapping process. This process continues until all frames 206 have been mapped. This is illustrated for a defined number of frames 206 in FIGS. 7 to 10.

An alternative way of viewing this embodiment is to consider it identical to the first embodiment 10, with the exception that the reference point 38 for each planar array 34 is identical for each frame 16. This then allows the three planar arrays 34 to be “merged” for the purposes of the mapping process.

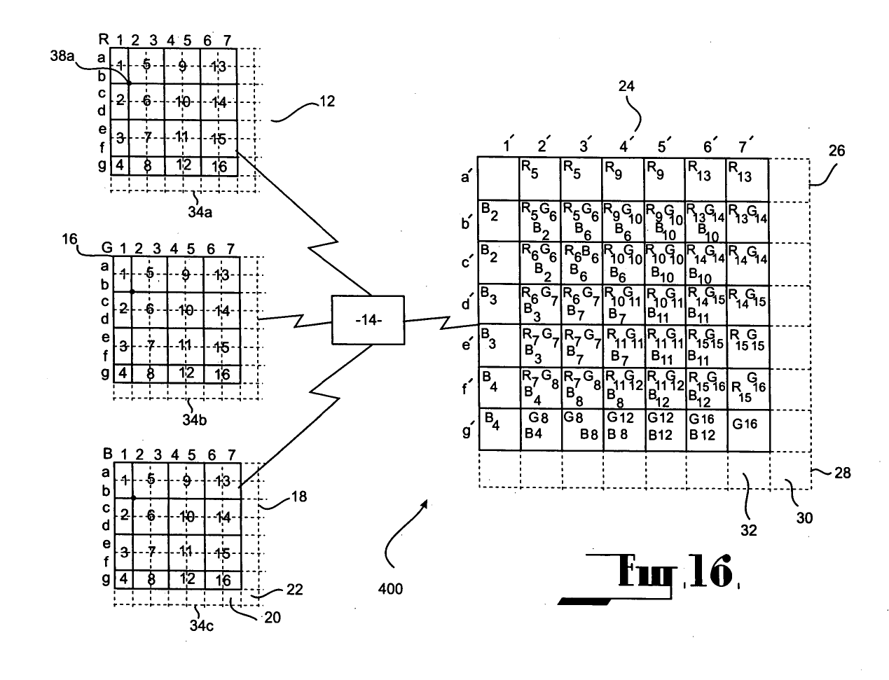

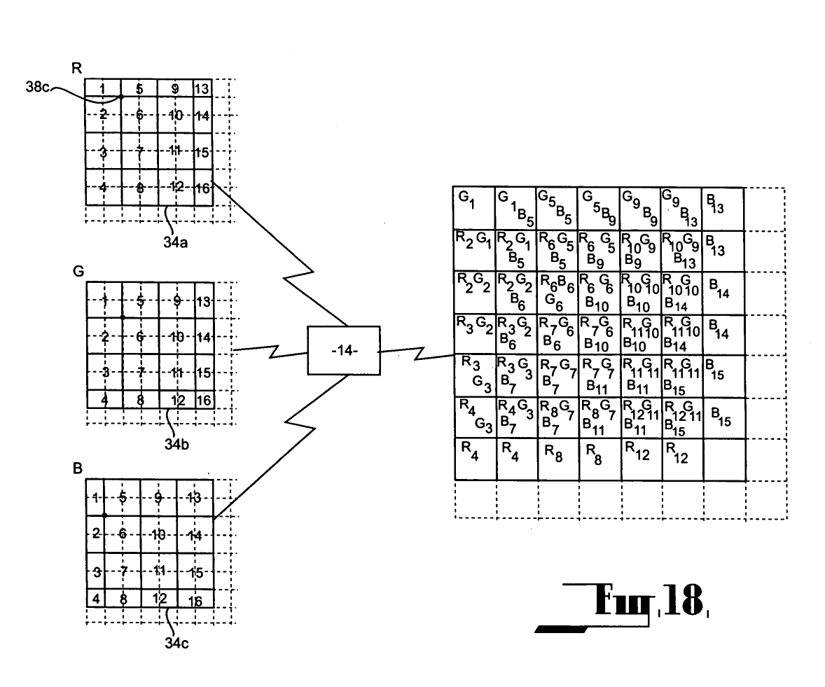

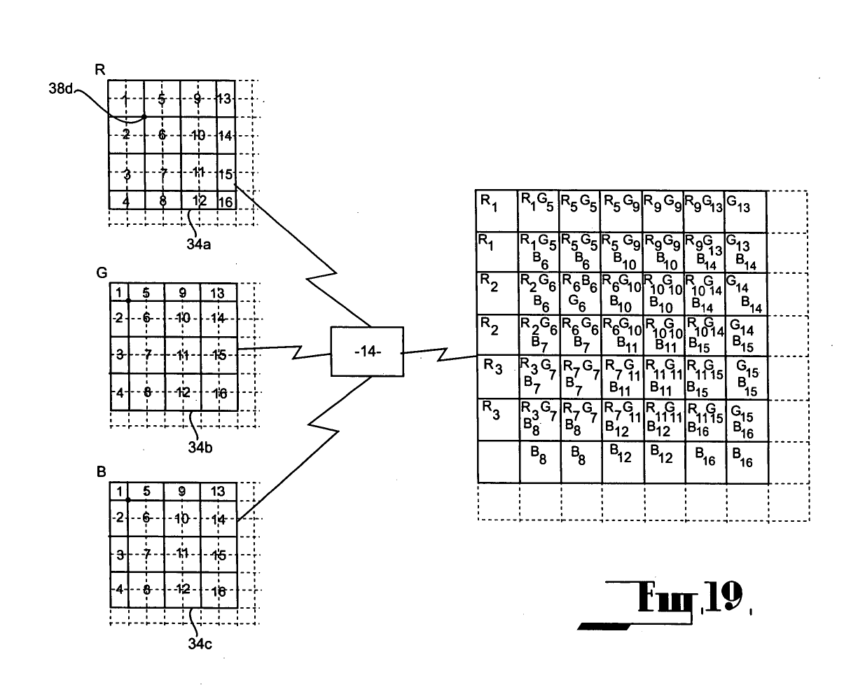

In accordance with a third embodiment of the invention, where like numerals refer to like parts described in the second embodiment of the invention, there is a system 300 for transforming graphics data. The system 300 is shown in FIGS. 11 to 15 in the abstract.

As indicated in FIGS. 11 to 15, frames 216 comprise a two-dimensional array 218 of graphics information 220. However, the size of each array 216 is a predetermined order of magnitude smaller than the size of array 208. In this embodiment, the mapping process will be described in the context of an example where the order of magnitude reduction is set to 2.

As with the mapping process described in the second embodiment, the array 208 of pixels 212 of the frame 206 of the graphics data 202 is divided into segments 224. Segments 224 are created by dividing the frame 206 in to a series of pixel “squares”—each side of the square having a length in pixels 20 equal to the order of magnitude reduction. The division commences from a predetermined first reference point 226a. This means that the segments 224 at the boundaries of the frame 16 may have less number of pixels 212 therein, and potentially vary in shape, as a result of the number of pixels 212 in either the x or y dimension of the array 208 not being evenly divisible by the order of magnitude reduction (for examples, see segments #1 and #4). This may also occur in situations where the number of pixels 212 in either the x or y dimension of the array 208 are evenly divisible by the order of magnitude reduction, but the position of the predetermined first reference point 226a does not allow for equal division of the frame 206.

Focus will now be placed on the two highlighted segments 224 shown in FIG. 11. For the first segment 224a shown, the segment 224a includes pixels 212 having (x, y) values as follows {(b,3), (b,4), (c,3), (c,4)}. For the second segment 224b shown, the segment 224b includes pixels 212 having (x, y) values as follows: {(b,5), (b,6), (c,5), (c,6)}.

The pixels 212 forming the first segment 224a are mapped to pixel (b′,5′) 222 in frame 216. Similarly, the pixels 212 forming the second segment 224b are mapped to pixel (b′,6′) 222 in frame 216. The realignment of the mapped pixel 222 within frame 216 relative to the position of the segment 224a, 224b from which it is derived within frame 206 is necessary to avoid gaps in the transformed graphic images.

In addition to mapping segments 224 to pixels 222, the attributes of the mapped pixel 222 are derived from the attributes of the pixels 212 in the segment 224 from which it is derived. In this example, the set of colour attributes of the mapped pixel 222 are inherited from the pixel 212 within the segment 224 from which it is derived holding a predetermined position (ie. in abstraction terms, the upper left, lower right position, etc.).

The predetermined first reference point 226a is then shifted in accordance with a defined oscillation sequence to form a second reference point 226b.

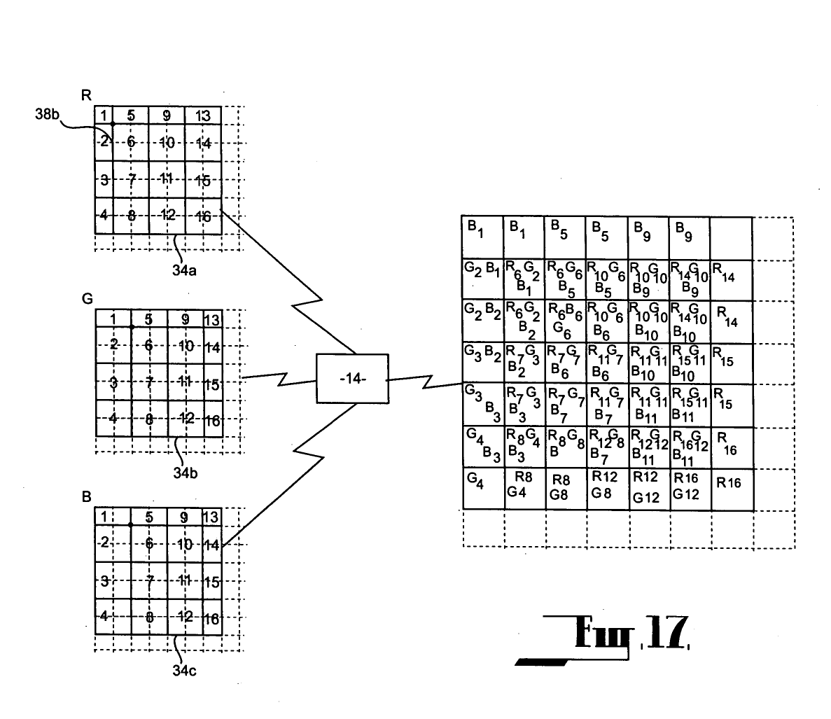

Turning to FIG. 12, segments 224 are created in the next frame 206 in the same manner as described above but commencing from the second reference point 226b.

Again looking at the two highlighted segments 224a, 224b, it is to be noted that the segments 224a, 224b have moved such that the first segment 224a now includes pixels having (x, y) values as follows: {(b,2), (b,3), (c,2), (c,3)}. For the second segment 224b, the segment 224b now includes pixels 212 having (x, y) values as follows: {(b,4), (b,5), (c,4), (c,5)}.

For the reasons described above, the pixels 212 forming the first segment 224a are again mapped to pixel (b′,5′) 222 in frame 216 and the pixels 212 forming the second segment 224b are again mapped to pixel (b′,6′) 222. The set of colour attributes for the new pixels 222 are also inherited from the attributes of a pixel 212 within the segments 224 from which they are derived as per the process described above.

The second reference point 226b is then shifted in accordance with the defined oscillation sequence to form a third reference point 226c.

This process is then repeated, where, for each new frame 206 the reference point 226 for dividing the frame 206 into segments 224 is reorientated in accordance with the defined oscillation sequence. This is illustrated further in FIGS. 13 to 15.

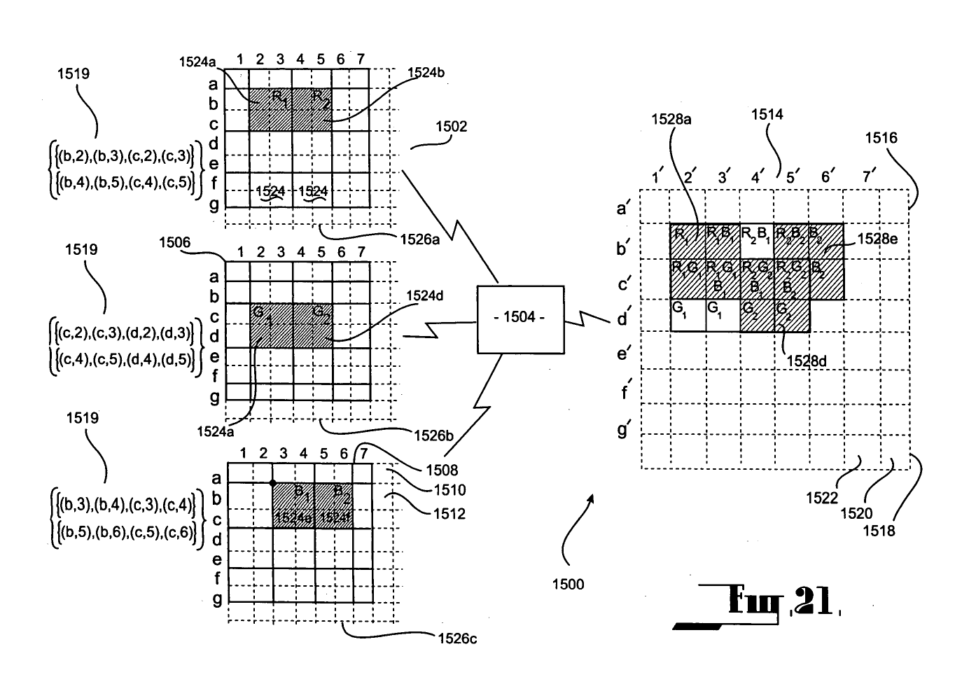

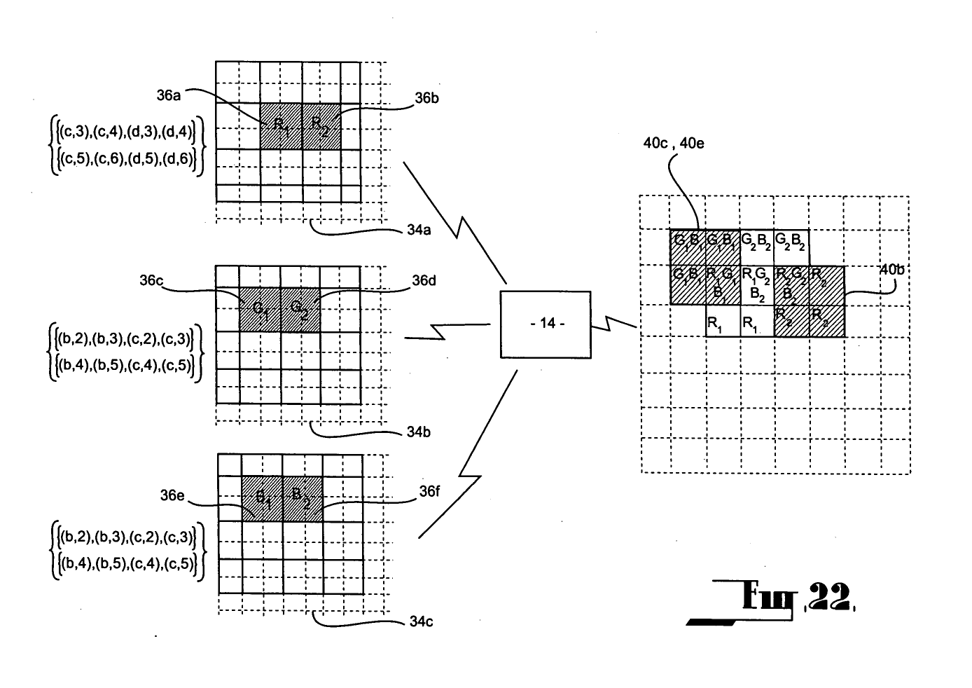

In accordance with a fourth embodiment of the present invention, where like numerals reference like parts described in the first embodiment of the invention, there is a system 400 for transforming graphics data. In this the fourth embodiment, the process by which the transformation processor 14 manipulates the graphics data 12 to form transformed graphics data 24 is described below with reference to the schematics depicted in FIGS. 16 to 20. It should again be noted that the schematics shown in FIGS. 16 to 20 are abstractions.

In this the fourth embodiment the graphics information takes the form of a pixel 22 having a set of colour attributes including:

a red colour intensity value for the pixel 22;

a green colour intensity value for the pixel 22; and

a blue colour intensity value for the pixel 22.

Frames 16 are again divided into planar arrays 34a, 34b, 34c based on colour intensity values.

As shown in FIG. 16, each planar array 34 of the frame 16 of the graphics data 12 is divided into segments 36. The method of dividing each planar array 34 into segments 36 will now be described in the context of planar array 34a. Segments are created by dividing the planar array 34a into a series of pixel “squares”. In this embodiment, the side of each segment 36 “Square” has a length of two pixels. This division commences from a predetermined first reference point 38a. This means that the segments 36 at the boundaries of the planar array 34a may have a lesser number of pixels 22 therein, and potentially vary in shape, as a result of the number of pixels 22 in either the x or y dimension of the planar array 34a not being evenly divisible by the length of the side of each segment 36 “square” (see segments labelled #1 and #4). This may also occur in situations where the number of pixels 22 in either the x or y dimension of the planar array 34a are evenly divisible by the length of the side of segment 36 “square”, but the position of the predetermined first reference point 38a does not allow for equal division of the planar array 34a.

In this embodiment, however, only those segments 36 having a full complement of pixels 20 are mapped to a segment 40 in the frame 26 of the transformed graphics data 24. The reason for deleting segments 36 not having a full complement of pixels 20 is to smooth the resulting displayed image of the transformed graphics data 22. It having been found that the mapping of pixels 28 from segments 30 not having a full complement of pixels produces a flickering effect during display.

For those pixels 20 where a full set of attributes have not been mapped, the missing attributes are determined by averaging the corresponding attribute values of the surrounding mapped pixels 20.

Alternatively, the missing attributes may be inherited from the previous frame or deduced using predictive techniques.

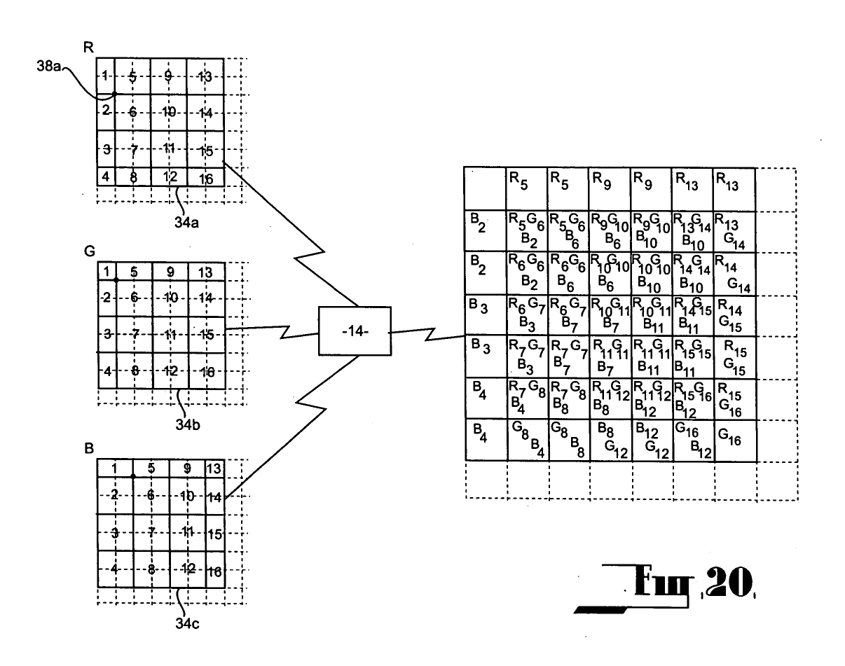

As before the process is repeated, where, for each new frame 16 the reference point 38 for dividing the frame 16 into segments 32 is recalculated using the defined oscillation sequences for each planar array 34. This is illustrated in FIGS. 17 to 20.

In accordance with a fifth embodiment of the invention, where like numerals reference like parts described in the first embodiment of the invention, there is a system for transforming graphics data. In this fifth embodiment, the mapping process is modified such that the colour intensity value for pixels 32 in the segment 40 is the average of the colour intensity value for a predetermined set of pixels 22 in the segment 34 it is mapped from (defined with reference to their location within the segment 34). While the predetermined set may contain less than the total number of pixels 22 in the segment 34, ideally the predetermined set contains all pixels 22 in the segment, and it is in this context that an example will be made.

To elaborate, with reference to the initial mapping process described in the first embodiment, using the mapping process described in this embodiment the colour intensity values for pixels 32 can be clearly shown with reference to the following table.

| | |
|---|---|
| (b′, 2′) | the average of the red colour intensity value of the pixels 22 |
| | within segment 36a. |
| (b′, 3′) | the average of the red colour intensity value of the pixels 22 |
| | within segment 36a. |
| | the average of the blue colour intensity value of the pixels 22 |
| | within segment 36e. |
| (b′, 4′) | the average of the red colour intensity value of the pixels 22 |
| | within segment 36b. |
| | the average of the blue colour intensity value of the pixels 22 |
| | within segment 36e. |
| (b′, 5′) | the average of the red colour intensity value of the pixels 22 |
| | within segment 36b. |
| | the average of the blue colour intensity value of the pixels 22 |
| | within segment 36f. |
| (b′, 6′) | the average of the blue colour intensity value of the pixels 22 |
| | within segment 36f. |
| (c′, 2′) | the average of the red colour intensity value of the pixels 22 |
| | within segment 36a. |
| | the average of the green colour intensity value of the pixels 22 |
| | within segment 36c. |
| (c′, 3′) | the average of the red colour intensity value of the pixels 22 |
| | within segment 36a. |
| | the average of the green colour intensity value of the pixels 22 |
| | within segment 36c. |
| | the average of the blue colour intensity value of the pixels 22 |
| | within segment 36e. |
| (c′, 4′) | the average of the red colour intensity value of the pixels 22 |
| | within segment 36b. |
| | the average of the green colour intensity value of the pixels 22 |
| | within segment 36d. |
| | the average of the blue colour intensity value of the pixels 22 |
| | within segment 36e. |
| (c′, 5′) | the average of the red colour intensity value of the pixels 22 |
| | within segment 36b. |
| | the average of the green colour intensity value of the pixels 22 |
| | within segment 36d. |
| | the average of the blue colour intensity value of the pixels 22 |
| | within segment 36f. |
| (c′, 6′) | the average of the blue colour intensity value of the pixels 22 |
| | within segment 36f. |
| (d′, 2′) | the average of the green colour intensity value of the pixels 22 |
| | within segment 36c. |
| (d′, 3′) | the average of the green colour intensity value of the pixels 22 |
| | within segment 36c. |
| (d′, 4′) | the average of the green colour intensity value of the pixels 22 |
| | within segment 36d. |
| (d′, 5′) | the average of the green colour intensity value of the pixels 22 |
| | within segment 36d. |

It is further possible that the predetermined set used to obtain a colour value may differ to one or more of the predetermined sets used to obtain the other colour values.

In accordance with a sixth embodiment of the invention, where like numerals reference like parts described in the second embodiment of the invention, there is a system for transforming graphics data. In this sixth embodiment, the set of colour attributes for the mapped segment 240 are derived by taking one or more colour intensity values from the attributes of a predetermined set of pixels 212 in the segment 234 from which it is derived.

In this manner, the red colour intensity value for pixels 222 in segment 234 is the average of the red colour intensity values for a first predetermined set of pixels 212 bounded by the segment 234 from which it is derived. The green colour intensity value for pixels 222 in segment 234 is the average of the green colour intensity values for a second predetermined set of pixels 212 bounded by the segment 234 from which it is derived. Similarly, the blue colour intensity value for pixels 222 in segment 234 is the average of the blue colour intensity values for a third predetermined set of pixels 212 bounded by the segment 234 from which it is derived.

It is further possible within the context of this embodiment for one or more predetermined set of pixels 212 to be identical.

In accordance with a seventh embodiment of the invention, where like numerals refer to like parts described in the first embodiment, there is a system for transforming graphics data. In this, the seventh embodiment of the invention, the defined oscillation sequence determines the next reference point 38 as a function of the sequence value of the frame 16 processed (or, as an alternative, the sequence value of the frame 16 to be processed).

In accordance with an eight embodiment of the invention, where like numerals refer to like parts described in the first embodiment, there is a system for transforming graphics data. In this, the eighth embodiment of the invention, the defined oscillation sequence determines the next reference point 38 as a function of an external factor. In such an arrangement, the external factor may be:

the current time of a real-time clock; or

the number of sequencing pulses issued by a sequencer, that forms part of the transformation processor 14, or that forms part of a data processing apparatus upon which the transformation processor 14 operates.

The external factor may also be a value of a pseudo-random function of the transformation processor 14 or the data processing apparatus upon which the transformation processor 14 operates.

In accordance with a ninth embodiment of the invention, where like numerals refer to like parts described in the first embodiment, there is a system for transforming graphics data. In this, the ninth embodiment, the defined oscillation sequence repeats after oscillating through a predetermined number of states.

For instance, in one example, the defined oscillation sequence is a modulation function of the sequence value. To elaborate, with Z being a reference to the sequence value, the reference points 38 may be determined as follows:

| for Z mod 4 = | Reference Points |
|---|---|
| 0 | Reference point 38a = (a, 1); |
| | Reference point 38b = (a, 2); |
| | Reference point 38c = (b, 1) |
| 1 | Reference point 38a = (a, 2) |
| | Reference point 38b = (b, 1) |
| | Reference point 38c = (b, 2) |
| 2 | Reference point 38a = (b, 2) |
| | Reference point 38b = (b, 2) |
| | Reference point 38c = (a, 2) |
| 3 | Reference point 38a = (b, 1) |
| | Reference point 38b = (a, 1) |
| | Reference point 38c = (a, 1) |

Thus, in a situation where the number of pixels 22 in a segment 36 equals 4, it can be shown that in the above example, the reference points 38 oscillate through every possible pixel within the first segment 36.

While a high number of repetitions in the oscillation sequence is preferred, under current processing technology it has been found that limiting the number of repetitions to 8 is preferred, being a third of the number of frames to be displayed in a second. However, as processing technology further improves, a greater number of repetitions in the oscillation sequence should be possible without degrading the image due to processing backlogs.

In accordance with a tenth embodiment of the invention, where like numerals refer to like parts described in the first embodiment, there is a system for transforming graphics data. In this, the tenth embodiment, the predefined oscillation sequence may be any one of the following types:

harmonic;

non-harmonic;

chaos; and

non-linear.

In accordance with an eleventh embodiment of the invention, where like numerals refer to like parts described in the first embodiment, there is a system for transforming graphics data. In this, the eleventh embodiment, the predefined oscillation sequence is omitted. In its place, each reference point 36 is determined completely at random.

Alternatively, each reference point 36 is determined by moving the reference point 36 a predetermined number of pixels 22 in a randomly determined direction after processing a frame 16.

In accordance with a twelfth embodiment of the invention, where like numerals refer to like parts described in the first embodiment, there is a system for transforming graphics data. In this, the twelfth embodiment, the frame 16 remains divided into three planar arrays 24a, 24b, 24c. However, while the mapping of planar arrays 24b and 24c occur as described in the first embodiment, the mapping of planar array 24a is determined on a direct correlation basis.

To elaborate, each pixel 32 in frame 34 has the same red colour intensity value as the pixel 22 having the corresponding (x, y) location within frame 16. However, the green colour intensity value and blue colour intensity value for the same pixel 32 is determined according to the mapping process described in the first embodiment.

In alternative variations of this the twelfth embodiment, one or more of the planar arrays 24 may be mapped on a direct correlation basis while the remaining planar arrays 24 are mapped using the process described in the first embodiment.

In accordance with a thirteenth embodiment of the invention, where like numerals refer to like parts described in the first embodiment, there is a system for transforming graphics data. This, the thirteenth embodiment, is directed towards situations where there is little visual difference between a predetermined number of sequential frames 16. The need for this embodiment arises out of the fact that after a predetermined number of frames 16, presently considered to be 15 frames 16, the movement of graphics information 20 can not be masked by the minimal visual differences between the frames 16. The end result is that the brain interprets the movement of graphics information 20 as a twinkling of the image.

To avoid this effect, the system includes a receiving terminal (not shown). The receiving terminal receives the transformed graphics data. The receiving terminal then operates to display the transformed graphics data at an increased frame rate. In the preferred embodiment, the receiving terminal achieves this increased frame rate by displaying each frame of the transformed graphics data three times. The order is maintained, such that the thrice display of each frame happens sequentially.

While each frame is displayed three times, each frame varies. This variation is achieved by moving each frame in accordance with a second predefined oscillation sequence. This second predefined oscillation sequence need not be limited to the number of repetitions of the same frame.

In this manner the increased visual information overloads the brain's ability to process the visual information, thus negating the “twinkling” effect referred to above.

In accordance with a fourteenth embodiment of the invention, where like numerals refer to like parts described in the first embodiment, there is a system for transforming graphics data. In this, the fourteenth embodiment, the graphics information 20 may be any base component, or representation of a base component, that can be used to display an image. In this manner, systems where an image is displayed by use of components other than pixels are still intended to be covered by the invention.

In accordance with a fifteenth embodiment of the invention, there is a system for transforming graphics data 1500 comprising:

graphics data 1502; and

a transformation processor 1504.

The graphics data 1502 comprises a set of frames 1506. Frames 1506 have a temporal locality, hereafter referred to as a sequence value, to indicate the order in which the set of frames 1506 should be displayed. Each frame 1506 comprises a two-dimensional array 1508 of graphics information 1510.

Each graphics information 1510 has two spatial localities, referred to hereafter as its x location and its y location respectively. The x and y values also represent the location of the graphics information 1510 within the array 1508.

In this embodiment, the graphics information 1510 takes the form of a pixel 1512. Each pixel 1512 has a set of colour attributes. For the purposes of the following example, the set of colour attributes includes:

a red colour intensity value for the pixel 1512;

a green colour intensity value for the pixel 1512; and

a blue colour intensity value for the pixel 1512.

In its totality, the graphics data 1502 shows a video image. As the means by which a video image can be displayed using a set of frames 1506 and a sequence value will be known to the person skilled in the art, it will not be described in more detail here.

The transformation processor 1504 manipulates the graphics data 1502 to form transformed graphics data 1514. The transformed graphics data 1514 comprises a set of frames 1516 like the frames 1506 of graphics data 1502, frames 1516 have a sequence value, to indicate the order in which the set of frames 1516 should be displayed. Each frame 1516 comprises a two dimensional array 1518 of graphics information 1520.

As above, in this embodiment the graphics information 1520 takes the form of pixels 1522. The pixels 1522 have the same characteristics as pixels 1512.

Associated with each sequence value is a set of segment co-ordinates 1519. Each segment co-ordinates 1519 defines a segment 1524 (discussed in more detail below). The segment co-ordinates 1519 may be a set of values that provide the x and y locations of each pixel that bounds the geometric shape of the segment 1524. Alternatively, the segment co-ordinates 1519 may be a set of values that provide the x and y locations of each pixel 1512 that forms part of the segment 1524. In either case, the set of segment co-ordinates 1519 must contain enough segment co-ordinates such that all pixels 1512 within a frame 1506 are covered by a segment 1524.

Each segment co-ordinates 1519 in the set of segment co-ordinates 1519 associated with a sequence value must define a different set of segments 1524 than those defined in the set of segment co-ordinates 1519 for the sequence value either side of it (ie. The set of segment co-ordinates associated with sequence value ±1). Ideally, the difference between each segment 1524 in the set of segment co-ordinates 1519 associated with a sequence value and each segment 1524 in the set of segment co-ordinates 1519 associated with a sequence value either side is determined with reference to a predefined oscillation sequence.

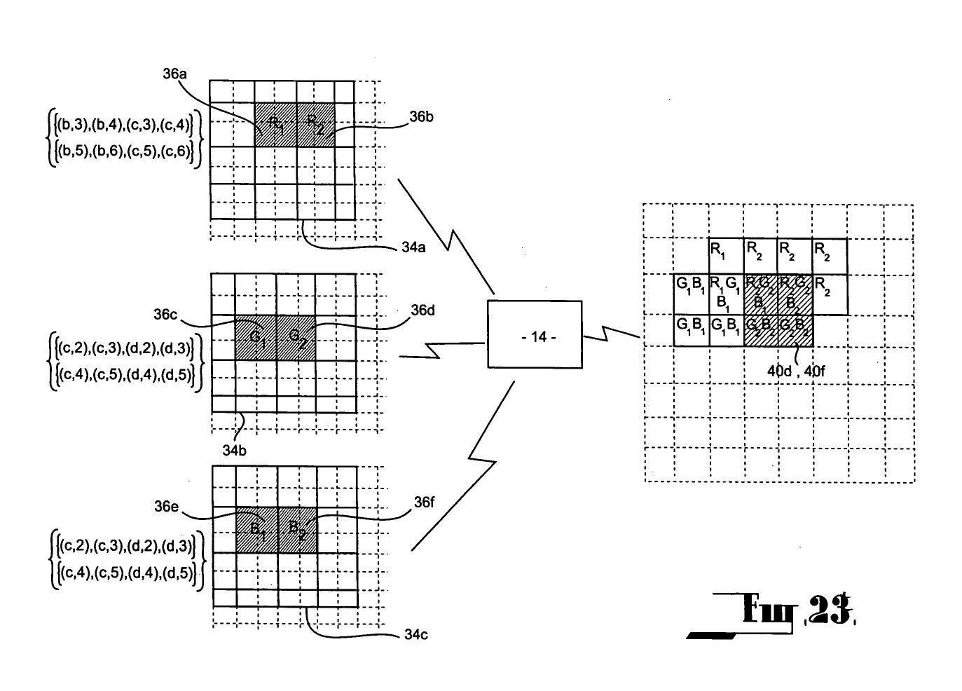

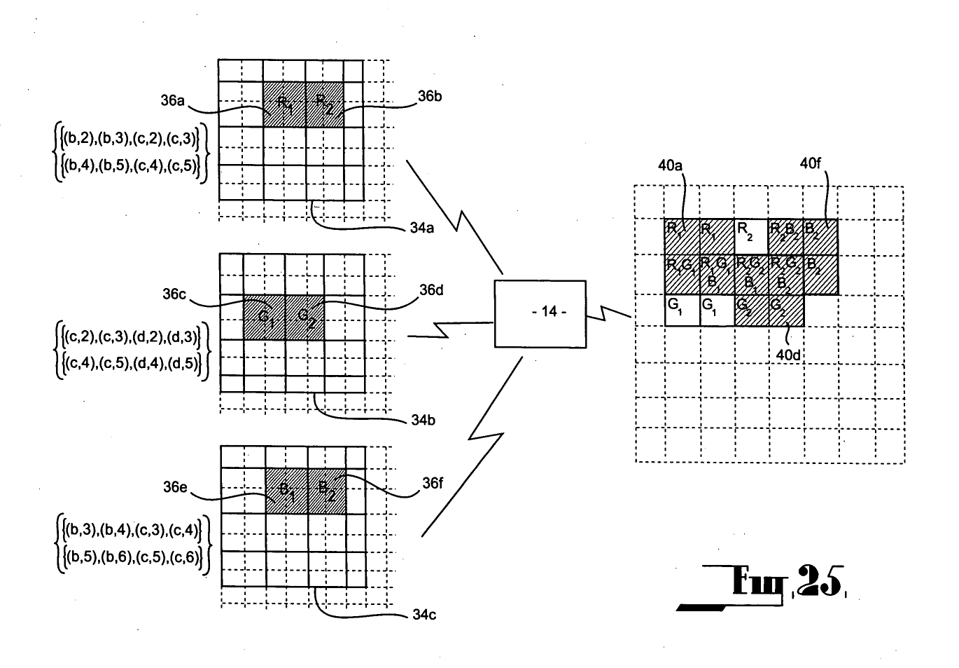

The process by which the transformation processor manipulates the graphics data to form transformed graphics data 1514 is described below with reference to the schematics depicted in FIGS. 21 to 25. It should be noted that the schematics shown in FIGS. 21 to 25 are abstractions, as graphics data 1502 will commonly be embodied by a disk or electronic memory or other computer readable storage device.

By way of initial description FIGS. 21 to 25 each depict a frame 1506 from the set of graphics data 1502 and its corresponding frame 1516 in the transformed set of graphics data 1514 (as determined by their sequence values). The frame 1506 is divided into three separate planar arrays 1526. Each planar array 1526 represents a colour intensity value for the pixels 1512 of the frame 1506. As a result:
planar array 1526a is representative of the red colour intensity value for each pixel 1512 of the frame 1506;
planar array 1526b is representative of the green colour intensity value for each pixel 1512 of the frame 1506; and
planar array 1526c is representative of the blue colour intensity value for each pixel 1512 of the frame 1506.

Each planar array 1526 is equal in size to array 1508.

They values of each pixel 1512 in the planar arrays 1526 shown in FIG. 21 are labelled by the values a to g. The x values of each pixel 1512 in the planar arrays 1524 shown in FIG. 21 are labelled by the values 1 to 7. Corresponding references are used in relation to each frame 1516 from the set of transformed graphics data, but distinguished by use of the ′ symbol.

While not depicted in FIGS. 22 to 24, the x and y values for each planar array 1526 will be referred to using the same label references as shown in FIG. 21.

The embodiment of the system 1500 will now be described in the context of the following example.

As shown in FIG. 21, the array 1508 of pixels 1512 of the frame 1506 of the graphics data 1502 is divided into segments 1524. Segments 1524 are illustrated in FIG. 21 as bound by a solid line while the pixels 1512 within each segment 1524 are bound by dotted lines, except where the boundary of the pixel 1512 intersects with the boundary of a segment 1524.

The method of dividing each planar array 1526 into segments 1524 will now be described in the context of planar array 1526a. Segments 1524 are created with reference to the set of segment co-ordinates 1519. As mentioned above, each pixel 1512 in the frame 1506 must be covered by a segment 1524 as defined in the set of segment co-ordinates 1519. As a result, the segments 1524 at the boundaries of the frame 1506 may have a lesser number of pixels 1512 then the segments 1524 not located at the boundaries.

The same method used to divide planar array 1526a into segments 1524, as described in the last paragraph, is used to divide planar arrays 1526b, 1526c into segments 1524. It should be noted that in the context of this example, the set of segment co-ordinates 1519 differs from one planar array 1526 to the next.

Focus will now be placed on the six highlighted segments 1524 shown in FIG. 21. Segments 1524a, 1524b are segments within planar array 1526a. Segments 1524c, 1524d are segments within planar array 1526b. Segments 1524e, 1524f are segments within planar array 1526c.

For the first segment 1524a shown, the segment 1524a includes pixels 1512 having (x, y) values as follows: {(b,2), (b,3), (c,2), (c,3)}. As in this embodiment the set of segment co-ordinates 1519 is defined by way of the x and y locations of each pixel 1512 that bounds the geometric shape of the segment 1524, the first segment 1524a is defined in the set of segment co-ordinates 1519 for planar array 1526a as values {(b,2), (b,3), (c,2), (c,3)}. For the second segment 1524b, the segment 1524b includes pixels 1512 having (x, y) values as follows: {(b,4), (b,5), (c,4), (c,5)}. Again the second segment 1524b is defined in the set of segment co-ordinates 1519 for planar array 1526a as values {(b,4), (b,5), (c,4), (c,5)}.

For the third segment 1524c shown, the segment 1524c includes pixels 1512 having (x, y) values as follows: {(c,2), (c,3), (d,2), (d,3)}. This third segment 1524c is defined in the set of segment co-ordinates 1519 for planar array 1526b as values {(c,2), (c,3), (d,2), (d,3)}. For the fourth segment 1524d, the segment 1524d includes pixels 1512 having (x, y) values as follows: {(c,4), (c,5), (d,4), (d,5)}. Again the fourth segment 1524d is defined in the set of segment co-ordinates 1519 for planar array 1526b as values {(c,4), (c,5), (d,4), (d,5)}.

For the fifth segment 1524e shown, the segment 1524e includes pixels 1512 having (x, y) values as follows: {(b,3), (b,4), (c,3), (c,4)}. This fifth segment 1524e is defined in the set of segment co-ordinates 1519 for planar array 1526c as values {(b,3), (b,4), (c,3), (c,4)}. For the sixth segment 1524f, the segment 1524f includes pixels 1512 having (x, y) values as follows: {(b,5), (b,6), (c,5), (c,6)}. Again the sixth segment 1524f is defined in the set of segment co-ordinates 1519 for planar array 1526c as values {(b,5), (b,6), (c,5), (c,6)}.

The pixels 1512 forming the first segment 1524a are mapped to a corresponding segment 1528a in frame 1516. Segment 1528a is easily determined as the pixels 1522 within segment 1528a each have a corresponding (x, y) value to a pixel 1512 in segment 1524a.

This mapping is limited to the red colour intensity value of each pixel 1522 within segment 1528a. To elaborate, the red colour intensity value for each pixel 1522 within segment 1528a is inherited from the pixel 1512 within segment 1524a holding a predetermined position (ie. In abstraction terms, the upper left position, lower right position, etc.).

The pixels 1512 forming the second segment 1524b are mapped to pixels 1522 within corresponding frame 1528b in the same manner as described in the last two paragraphs.

The pixels 1512 forming the third segment 1524c are mapped to a corresponding segment 1528c in frame 1516. Segment 1528c is easily determined as the pixels 1522 within segment 1528c each have a corresponding (x, y) value to a pixel 1512 in segment 1524c.

This mapping is limited to the green colour intensity value of each pixel 1522 within segment 1528c. To elaborate, the green colour intensity value for each pixel 1522 within segment 1528c is inherited from the pixel 1512 within segment 1524c holding a predetermined position (ie. In abstraction terms, the upper left position, lower right position, etc.).

The pixels 1512 forming the fourth segment 1524d are mapped to pixels 1522 within corresponding frame 1528d in the same manner as described in the last two paragraphs.

The pixels 1512 forming the fifth segment 1524e are mapped to a corresponding segment 1528e in frame 1516. Segment 1528e is easily determined as the pixels 1522 within segment 1528e each have a corresponding (x, y) value to a pixel 1512 in segment 1524e.

This mapping is limited to the blue colour intensity value of each pixel 1522 within segment 1528e. To elaborate, the blue colour intensity value for each pixel 1522 within segment 1528e is inherited from the pixel 1512 within segment 1524e holding a predetermined position (ie. In abstraction terms, the upper left position, lower right position, etc.).

The pixels 1512 forming the sixth segment 1524f are mapped to pixels 1522 within corresponding frame 1528f in the same manner as described in the last two paragraphs.

As a result of this mapping, the colour intensity values for pixels 32 can be clearly shown with reference to the following table.

| | |
|---|---|
| (b′, 2′) | the red colour intensity value of the pixel 1512 within segment |
| | 1524a holding the predetermined position for segment 1524a. |
| (b′, 3′) | the red colour intensity value of the pixel 1512 within segment |
| | 1524a holding the predetermined position for segment 1524a. |
| | the blue colour intensity value of the pixel 1512 within segment |
| | 1524e holding the predetermined position for segment 1524e. |
| (b′, 4′) | the red colour intensity value of the pixel 1512 within segment |
| | 1524b holding the predetermined position for segment 1524b. |
| | the blue colour intensity value of the pixel 1512 within segment |
| | 1524e holding the predetermined position for segment 1524e. |
| (b′, 5′) | the red colour intensity value of the pixel 1512 within segment |
| | 1524b holding the predetermined position for segment 1524b. |
| | the blue colour intensity value of the pixel 1512 within segment |
| | 1524f holding the predetermined position for segment 1524f. |
| (b′, 6′) | the blue colour intensity value of the pixel 1512 within segment |
| | 1524f holding the predetermined position for segment 1524f. |
| (c′, 2′) | the red colour intensity value of the pixel 1512 within segment |
| | 1524a holding the predetermined position for segment 1524a. |
| | the green colour intensity value of the pixel 1512 within segment |
| | 1524c holding the predetermined position for segment 1524c. |
| (c′, 3′) | the red colour intensity value of the pixel 1512 within segment |
| | 1524a holding the predetermined position for segment 1524a. |
| | the green colour intensity value of the pixel 1512 within segment |
| | 1524c holding the predetermined position for segment 1524c. |
| | the blue colour intensity value of the pixel 1512 within segment |
| | 1524e holding the predetermined position for segment 1524e. |
| (c′, 4′) | the red colour intensity value of the pixel 1512 within segment |
| | 1524b holding the predetermined position for segment 1524b. |
| | the green colour intensity value of the pixel 1512 within segment |
| | 1524d holding the predetermined position for segment 1524d. |
| | the blue colour intensity value of the pixel 1512 within segment |
| | 1524e holding the predetermined position for segment 1524e. |
| (c′, 5′) | the red colour intensity value of the pixel 1512 within segment |
| | 1524b holding the predetermined position for segment 1524b. |
| | the green colour intensity value of the pixel 1512 within segment |
| | 1524d holding the predetermined position for segment 1524d. |
| | the blue colour intensity value of the pixel 1512 within segment |
| | 1524f holding the predetermined position for segment 1524f. |
| (c′, 6′) | the blue colour intensity value of the pixel 1512 within segment |
| | 1524f holding the predetermined position for segment 1524f. |
| (d′, 2′) | the green colour intensity value of the pixel 1512 within segment |
| | 1524c holding the predetermined position for segment 1524c. |
| (d′, 3′) | the green colour intensity value of the pixel 1512 within segment |
| | 1524c holding the predetermined position for segment 1524c. |
| (d′, 4′) | the green colour intensity value of the pixel 1512 within segment |
| | 1524d holding the predetermined position for segment 1524d. |
| (d′, 5′) | the green colour intensity value of the pixel 1512 within segment |
| | 1524d holding the predetermined position for segment 1524d. |

Turning to FIG. 22, segments 1524 are created in the planar arrays 1526 for the next frame 1506 (as determined by the sequence value) in the same manner as described above but with reference to the set of segment co-ordinates 1519 for the new frame 1506.

Again looking at the six highlighted segments, for the first segment 1524a shown, the segment includes pixels 1512 having (x, y) values within planar array 1526a as follows: {(c,3), (c,4), (d,3), (d,4)}. This first segment 1524a is defined in the set of segment co-ordinates 1519 for planar array 1526a as values {(c,3), (c,4), (d,3), (d,4)}. For the second segment 1524b, the segment 1524b includes pixels 1512 having (x, y) values as follows: {(c,5), (c,6), (d,5), (d,6)}. Again, the second segment 1524b is defined in the set of segment co-ordinates 1519 for planar array 1526a as values {(c,5), (c,6), (d,5), (d,6)}.

For the third segment 1524c shown, the segment 1524c includes pixels 1512 having (x, y) values within planar array 1526b as follows: {(b,2), (b,3), (c,2), (c,3)}. This third segment 1524c is defined in the set of segment co-ordinates 1519 for planar array 1526b as values {(b,2), (b,3), (c,2), (c,3)}. For the fourth segment 1524d, the segment 1524d includes pixels 1512 having (x, y) values as follows: {(b,4), (b,5), (c,4), (c,5)}. Again, the fourth segment 1524d is defined in the set of segment co-ordinates 1519 for planar array 1526b as values {(b,4), (b,5), (c,4), (c,5)}.

For the fifth segment 1524e shown, the segment 1524e includes pixels 1512 having (x, y) values within planar array 1526c as follows: {(b,2), (b,3), (c,2), (c,3)}. This fifth segment 1524e is defined in the set of segment co-ordinates 1519 for planar array 1526c as values {(b,2), (b,3), (c,2), (c,3)}. For the sixth segment 1524f, the segment 1524f includes pixels 1512 having (x,y) values as follows: {(b,4), (b,5), (c,4), (c,5)}. Again, this sixth segment 1524f is defined in the set of segment co-ordinates 1519 for planar array 1526c as values {(b,4), (b,5), (c,4), (c,5)}.

The mapping process as described in respect of FIG. 21 is then repeated. As a result of this mapping, the colour intensity values for pixels 1522 can be clearly shown with reference to the following table.

| | |
|---|---|
| (b′, 2′) | the green colour intensity value of the pixel 1512 within segment |
| | 1524c holding the predetermined position for segment 1524c. |
| (b′, 3′) | the green colour intensity value of the pixel 1512 within segment |
| | 1524c holding the predetermined position for segment 1524c. |
| (b′, 4′) | the green colour intensity value of the pixel 1512 within segment |
| | 1524d holding the predetermined position for segment 1524d. |
| (b′, 5′) | the green colour intensity value of the pixel 1512 within segment |
| | 1524d holding the predetermined position for segment 1524d. |
| (c′, 2′) | the green colour intensity value of the pixel 1512 within segment |
| | 1524c holding the predetermined position for segment 1524c. |
| | the blue colour intensity value of the pixel 1512 within segment |
| | 1524e holding the predetermined position for segment 1524e. |
| (c′, 3′) | the red colour intensity value of the pixel 1512 within segment |
| | 1524a holding the predetermined position for segment 1524a. |
| | the green colour intensity value of the pixel 1512 within segment |
| | 1524c holding the predetermined position for segment 1524c. |
| | the blue colour intensity value of the pixel 1512 within segment |
| | 1524e holding the predetermined position for segment 1524e. |
| (c′, 4′) | the red colour intensity value of the pixel 1512 within segment |
| | 1524a holding the predetermined position for segment 1524a. |
| | the green colour intensity value of the pixel 1512 within segment |
| | 1524d holding the predetermined position for segment 1524d. |
| | the blue colour intensity value of the pixel 1512 within segment |
| | 1524f holding the predetermined position for segment 1524f. |
| (c′, 5′) | the red colour intensity value of the pixel 1512 within segment |
| | 1524b holding the predetermined position for segment 1524b. |
| | the green colour intensity value of the pixel 1512 within segment |
| | 1524d holding the predetermined position for segment 1524d. |
| | the blue colour intensity value of the pixel 1512 within segment |
| | 1524f holding the predetermined position for segment 1524f. |
| (c′, 6′) | the red colour intensity value of the pixel 1512 within segment |
| | 1524b holding the predetermined position for segment 1524b. |
| (d′, 2′) | the blue colour intensity value of the pixel 1512 within segment |
| | 1524e holding the predetermined position for segment 1524e. |
| (d′, 3′) | the red colour intensity value of the pixel 1512 within segment |
| | 1524a holding the predetermined position for segment 1524a. |
| | the blue colour intensity value of the pixel 1512 within segment |
| | 1524e holding the predetermined position for segment 1524e. |
| (d′, 4′) | the red colour intensity value of the pixel 1512 within segment |
| | 1524a holding the predetermined position for segment 1524a. |
| | the blue colour intensity value of the pixel 1512 within segment |
| | 1524f holding the predetermined position for segment 1524f. |
| (d′, 5′) | the red colour intensity value of the pixel 1512 within segment |
| | 1524b holding the predetermined position for segment 1524b. |
| | the blue colour intensity value of the pixel 1512 within segment |
| | 1524f holding the predetermined position for segment 1524f. |

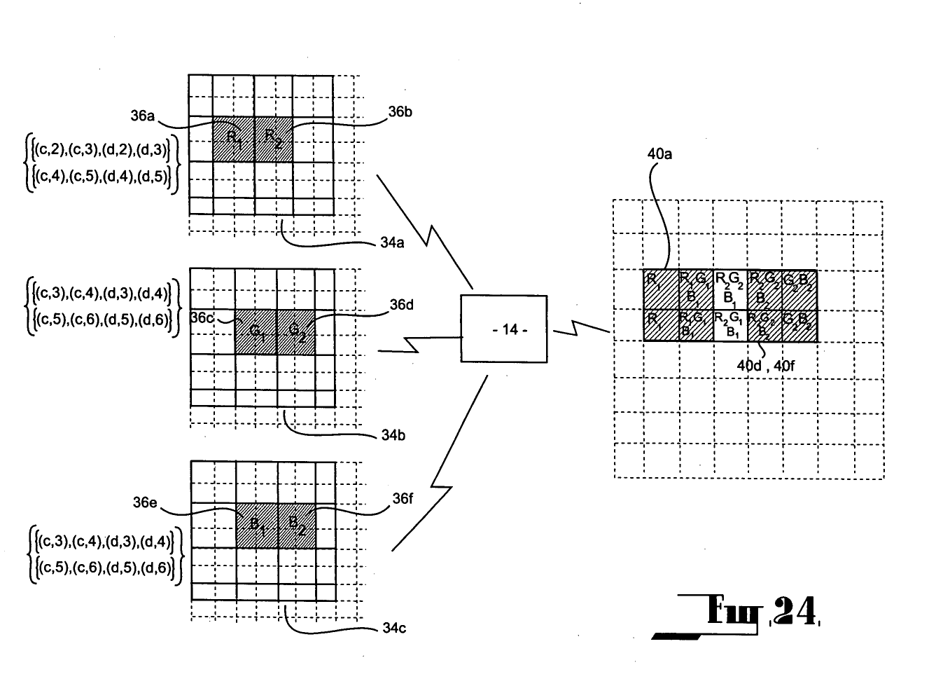

This process repeats as is illustrated in FIGS. 23 to 25.

It should be noted that the end result of the described embodiment is that each pixel 1522 in frame 1516 obtains a red colour intensity value, a green colour intensity value and a blue colour intensity value.

In this manner, the use of oscillating planar arrays of graphics information as the basis for determining the transformed set of graphics data 1514, when shown at an appropriate resolution and display rate, is operable to produce transformed graphics data 1514 having little, if any, variation in visual appearance to the visual appearance of the displayed graphics data 1502, as determined by a human eye. This is due to the fact that the movement of the transformed graphics data 1514 masks the pixellisation.

Further, the amount of data needed to store or transmit the transformed graphics data 1514 is significantly less than that needed to store or transmit the graphics data 1502 as only one colour intensity value per segment 1528 need be recorded, along with a means for determining the positions of each segment 1528, rather than needing to store a multiple of colour intensity values for each pixel 1522.

In accordance with a sixteenth embodiment of the invention, where like numerals reference like parts described in the thirteenth embodiment, there is a system for transforming graphics data. In this the sixteenth embodiment, variant frames 26 are displayed a number of times in an alternating fashion, rather than in a sequential fashion. To elaborate with reference to an example, the display sequence is as follows:

Frame 26 (sequence value=1a)

Frame 26 (sequence value=2a)

Frame 26 (sequence value=1b)

Frame 26 (sequence value=2b)

Frame 26 (sequence value=3a)

Frame 26 (sequence value=4a)

Frame 26 (sequence value=3b)

Frame 26 (sequence value=4b)

and so on . . .

It should be noted that while the above embodiments provide examples in the context of planar arrays or frames having equal sides of 7 or 9 pixels each, as the case may be, the invention is particularly suited towards graphics data 12 having a minimum resolution of 72 pixels per inch and a minimum display rate of 24 frames per second.

It should be appreciated by the person skilled in the art that the invention is not limited to the embodiments described. In particular, the following additions and/or modifications can be made without departing from the scope of the invention:
The transformation processor may be software or hardware based.
The temporal locality may be replaced by any value or other means by which the order of display of frames can be determined.
The graphics information may be pixels having a set of attributes representing the hue, saturation and brightness of the pixel. In such an arrangement, the planar arrays would not be representative of the colour intensity values of the pixels, instead being representative of the hue, saturation and brightness values for each pixel in a frame.
The graphics information may be pixels having a set of attributes representing the luminance and colour difference signals as used in the PAL colour television system. In such an arrangement, the planar arrays would not be representative of the colour intensity values of the pixels, instead being representative of the luminance, the B-Y colour difference signal and the R-Y colour difference signal for each pixel in a frame,
The graphics information may include such other information as is required to cover future developments in colour representation. Additional planar arrays may be needed to adequately implement such developments, with each planar array representative of the individual components that allow the colour to be represented through the development.
Graphics data 12 may be representative of a three-dimensional video image. Representing a three-dimensional video image is possible using the present invention by replacing the two-dimensional array of graphics information with a three-dimensional array of graphics information. Similarly, segmentation and mapping of the graphics information would need to be processed on a three-dimensional basis and not on the two-dimensional basis as described above.
Segment size may vary according to need. There is a practical restriction on the maximum segment sizes as there is a threshold point where the size of a segment will produce show pixellation in the resulting transformed graphics data regardless of frame rate and oscillation sequence used. The preferred segment size and shape is a square, each side of the square having a length of 3 pixels.
Segment shapes may vary according to need. Any interlocking shape may be used, provided that every pixel in a planar array can be covered using a repetitious pattern of the shape. In this manner, triangles, rectangles, parallelograms and diamond shapes may all be used in place of the square shape mentioned above. Further, a plurality of segment shapes that can be configured in an interlocking pattern, such as an octagon and square configuration, may also be used in place of a single segment shape.
The second embodiment of the invention can be modified such that the mapping process is not contained to a single pixel but may be reduced to a segment having a smaller size and/or a different shape than the segment from which it is derived.
Analogue video images can be processed using the above system by including a digitisation process as a preliminary step. Similarly, the system can be adapted to handle streaming of video images.
The above systems can be combined with interlacing techniques to further improve image quality.
The distance, in pixels, between reference points 34 from one iteration to another can be any size provided that image quality does not suffer. As a result, the preferred distance between reference points 34 from one iteration to another is 1 pixel.
The invention can be adapted for use with other display techniques, such as vector graphics.

It should be further appreciated by the person skilled in the art that features and modifications discussed in the embodiments above, not being alternatives or substitutes, can be combined to form yet other embodiments that fall within the scope of the invention described.

1. A system for transforming graphics data comprising:
graphics data; and
a transformation processor for creating transformed graphics data,
where the graphics data and transformed graphics data each comprise a set of frames, each frame in the set of frames comprising a temporal locality and an array of graphics information, the array having at least two dimensions and the graphics information having a set of attributes; and where the transformation processor creates each frame of the transformed graphics data by:
dividing the frame of graphics data having a corresponding temporal locality into segments;
dividing the frame of transformed graphics data into mapping segments, such that each mapping segment has at least one corresponding segment; and
for each segment, deriving at least one attribute from the set of attributes of at least one graphics information within the segment and including the derived at least one attribute in the set of attributes for each graphics information in its corresponding mapping segment,
and where the segments formed by dividing the frame of graphics data into segments differ between frames having adjacent temporal localities.

2. A system for transforming graphics data according to claim 1, where each segment comprises a group of graphics information having substantially similar first and second spatial localities within the array.

3. A system for transforming graphics data according to claim 1, where the transformation processor divides the frame of graphics data into segments with reference to a reference point.

4. A system for transforming graphics data according to claim 3, where the reference point changes from frame to frame in accordance with a first defined oscillation sequence.

5. A system for transforming graphics data according to claim 1, where the transformation processor divides the frame of graphics data into segments with reference to a set of segment co-ordinates.

6. A system for transforming graphics data according to claim 5, where each set of segment co-ordinates changes from frame to frame in accordance with a first defined oscillation sequence.

7. A system for transforming graphics data comprising:
graphics data; and
a transformation processor for creating transformed graphics data,
where the graphics data and transformed graphics data each comprise a set of frames, each frame in the set of frames comprising a temporal locality and an array of graphics information, the array having at least two dimensions and the graphics information having a set of attributes; and where the transformation processor creates each frame of the transformed graphics data by:
dividing the frame of graphics data having a corresponding temporal locality into a series of planar arrays, each planar array representative of at least one attribute from the set of attributes;
dividing each planar array into segments;
dividing the frame of transformed graphics data into mapping segments, such that each mapping segment has at least one corresponding segment from each planar array; and
for each segment in each planar array, deriving the at least one attribute represented by the planar array from at least one graphics information within the segment and including the derived at least one attribute in the set of attributes for each graphics information in the corresponding mapping segment for the planar array being processed,
and where the segments formed by dividing the planar arrays of graphics data into segments differ between frames having adjacent temporal localities and differ between at least two of the planar arrays.

8. A system for transforming graphics data according to claim 7, where the transformation processor divides each planar array into segments with reference to a set of reference points, each reference point in the set of reference points associated with a planar array.

9. A system for transforming graphics data according to claim 8, where each reference point in the set of reference points changes from frame to frame in accordance with a first defined oscillation sequence.

10. A system for transforming graphics data according to claim 7, where the transformation process divides the planar arrays into segments with reference to a set of segment co-ordinates, each segment co-ordinate in the set of segment co-ordinates associated with a planar array.

11. A system for transforming graphics data according to claim 10, where each set of segment co-ordinates changes from frame to frame in accordance with first a defined oscillation sequence.

12. A system for transforming graphics data according to claim 4, where the first defined oscillation sequence repeats after a predetermined number of iterations.

13. A system for transforming graphics data according to claim 4, where the first defined oscillation sequence is a function of the temporal locality.

14. A system for transforming graphics data according to claim 4, where the first defined oscillation sequence is a function of time as recorded by a time-measuring device.

15. A system for transforming graphics data according to claim 4, where the first defined oscillation sequence is a function of sequence pulses emitted by a sequencer.

16. A system for transforming graphics data according to claim 4, where the first defined oscillation sequence is a function of a pseudo-random generator.

17. A system for transforming graphics data according to claim 4, where the first defined oscillation sequence is a modulation function.

18. A system for transforming graphics data according to claim 3, where the difference in distance between reference points between frames having adjacent temporal localities is a single graphics information.

19. A system for transforming graphics data according to claim 3 where the orientation of reference points between frames having adjacent temporal localities is determined at random.

20. A system for transforming graphics data according to claim 1, where the at least one attribute is determined with reference to the position of the graphics information within the segment.

21. A system for transforming graphics data according to claim 7, where the at least one attribute is determined with reference to the position of the graphics information within the segment.

22. A system for transforming graphics data according to claim 1, where the at least one attribute is derived by averaging the corresponding attribute values of at least two graphics information within the segment.

23. A system for transforming graphics data according to claim 7, where the at least one attribute is derived by averaging the corresponding attribute values of at least two graphics information within the segment.

24. A system for transforming graphics data according to claim 1, where any segment having less than a predetermined number of graphics information is omitted by the transformation processor for the purposes of deriving the at least one attribute.

25. A system for transforming graphics data according to claim 7, where any segment having less than a predetermined number of graphics information is omitted by the transformation processor for the purposes of deriving the at least one attribute.

26. A system for transforming graphics data according to claim 1, where, in the abstract, each segment is an interlocking shape or a shape that, in combination with at least one other shape, creates an interlocking pattern.

27. A system for transforming graphics data according to claim 7, where, in the abstract, each segment is an interlocking shape or a shape that, in combination with at least one other shape, creates an interlocking pattern.

28. A system for transforming graphics data according to claim 26, where, each segment is a quadrilateral.

29. A system for transforming graphics data according to claim 27, where, each segment is a quadrilateral.

30. A system for transforming graphics data according to claim 28, where, each segment is a square.

31. A system for transforming graphics data according to claim 29, where, each segment is a square.

32. A system for transforming graphics data according to claim 30, where each segment has a side of length two graphics information.

33. A system for transforming graphics data according to claim 31, where each segment has a side of length two graphics information.

34. A system for transforming graphics data according to claim 30, where each segment has a side of length three graphics information.

35. A system for transforming graphics data according to claim 31, where each segment has a side of length three graphics information.

36. A system for transforming graphics data according to claim 1, where the array of each frame of the transformed graphics data has a smaller number of graphics information than the array of each frame of the graphics data.

37. A system for transforming graphics data according to claim 7, where the array of each frame of the transformed graphics data has a smaller number of graphics information than the array of each frame of the graphics data.

38. A system for transforming graphics data according to claim 36, where the size of each segment of the transformed graphics data is a single graphics information.

39. A system for transforming graphics data according to claim 37, where the size of each segment of the transformed graphics data is a single graphics information.

40. A system for transforming graphics data according to claim 1, further including a receiving terminal, the receiving terminal operable to display each frame of the transformed graphics data moved in accordance with a second defined oscillation sequence.

41. A system for transforming graphics data according to claim 7, further including a receiving terminal, the receiving terminal operable to display each frame of the transformed graphics data moved in accordance with a second defined oscillation sequence.

42. A system for transforming graphics data according to claim 40, where the receiving terminal operates to display each frame multiple times, each multiple display of the frame being moved in accordance with the second defined oscillation sequence.

43. A system for transforming graphics data according to claim 41, where the receiving terminal operates to display each frame multiple times, each multiple display of the frame being moved in accordance with the second defined oscillation sequence.

44. A system for transforming graphics data according to claim 40, where the receiving terminal displays frames in a predetermined alternating sequence.

45. A system for transforming graphics data according to claim 41, where the receiving terminal displays frames in a predetermined alternating sequence.

46. A system for transforming graphics data according to claim 40, where the second defined oscillation sequence repeats after a predetermined number of iterations.

47. A system for transforming graphics data according to claim 40, where the second defined oscillation sequence is a function of the temporal locality.

48. A system for transforming graphics data according to claim 40, where the second defined oscillation sequence is a function of time as recorded by a time-measuring device.

49. A system for transforming graphics data according to claim 40, where the second defined oscillation sequence is a function of sequence pulses emitted by a sequencer.

50. A system for transforming graphics data according to claim 40, where the second defined oscillation sequence is a function of a pseudo-random generator.

51. A system for transforming graphics data according to claim 40, where the second defined oscillation sequence is a modulation function.

52. A system for transforming graphics data according to claim 1, where at least one attribute from the set of attributes for each graphics information in the transformed graphics data is directly derived from the corresponding at least one attribute from the set of attributes for each graphics information in the graphics data.

53. A system for transforming graphics data according to claim 7, where at least one attribute from the set of attributes for each graphics information in the transformed graphics data is directly derived from the corresponding at least one attribute from the set of attributes for each graphics information in the graphics data.

54. A system for transforming graphics data according to claim 1, where the graphics information is any base component, or representation of a base component, that can be used to display an image.

55. A system for transforming graphics data according to claim 7, where the graphics information is any base component, or representation of a base component, that can be used to display an image.

56. A system for transforming graphics data according to claim 1, where each array has three dimensions.

57. A system for transforming graphics data according to claim 7, where each array has three dimensions.

58. A system for transforming graphics data according to claim 1, where the set of attributes includes a red colour intensity value, a green colour intensity value and a blue colour intensity value.

59. A system for transforming graphics data according to claim 1, where the set of attributes includes a hue value, a saturation value and a brightness value.

60. A system for transforming graphics data according to claim 1, where the set of attributes includes a luminance value, a B-Y colour difference value and a R-Y colour difference value.

61. A system for transforming graphics data according to claim 1, further including a digitiser, the digitiser operable to create graphics data from a set of analogue images.

62. A system for transforming graphics data according to claim 1, where the transformation processor adapts the transformed graphics data to include interlacing techniques.

63. A transformation processor for use in a system for transforming graphics data into transformed graphics data, the graphics data and transformed graphics data each comprising a set of frames, each frame in the set of frames comprising a temporal locality and an array of graphics information, the array having at least two dimensions and the graphics information having a set of attributes, where the transformation processor creates each frame of the transformed graphics data by:
dividing the frame of graphics data having a corresponding temporal locality into segments;
dividing the frame of transformed graphics data into mapping segments, such that each mapping segment has at least one corresponding segment; and
for each segment, deriving at least one attribute from the set of attributes of at least one graphics information within the segment and including the derived at least one attribute in the set of attributes for each graphics information in its corresponding mapping segment,
and where the segments formed by dividing the frame of graphics data into segments differ between frames having adjacent temporal localities.

64. A transformation processor according to claim 63, operable to divide the frame of graphics data having a corresponding temporal locality into segments, each segment comprising a group of graphics information having substantially similar first and second spatial localities within the array.

65. A transformation processor according to claim 63, operable to divide the frame of graphics data into segments with reference to a reference point.

66. A transformation processor according to claim 64, operable to redetermine the position of each reference point from frame to frame in accordance with a first defined oscillation sequence.

67. A transformation processor according to claim 63, operable to divide the frame of graphics data into segments with reference to a set of segment co-ordinates.

68. A transformation processor according to claim 67, operable to redetermine each segment co-ordinate in the set of segment co-ordinates from frame to frame in accordance with a first defined oscillation sequence.

69. A transformation processor for use in a system for transforming graphics data into transformed graphics data, the graphics data and transformed graphics data each comprising a set of frames, each frame in the set of frames comprising a temporal locality and an array of graphics information, the array having at least two dimensions and the graphics information having a set of attributes, where the transformation processor creates each frame of the transformed graphics data by:
dividing the frame of graphics data having a corresponding temporal locality into a series of planar arrays, each planar array representative of at least one attribute from the set of attributes;
dividing each planar array into segments;
dividing the frame of transformed graphics data into mapping segments, such that each mapping segment has at least one corresponding segment from each planar array; and
for each segment in each planar array, deriving the at least one attribute represented by the planar array from at least one graphics information within the segment and including the derived at least one attribute in the set of attributes for each graphics information in the corresponding mapping segment for the planar array being processed,
and where the segments formed by dividing the planar arrays of graphics data into segments differ between frames having adjacent temporal localities and differ between at least two of the planar arrays.

70. A transformation processor according to claim 69, operable to divide each planar array into segments with reference to a set of reference points, each reference point in the set of reference points associated with a planar array.

71. A transformation processor according to claim 70, operable to redetermine the position of the reference point in the set of reference points from frame to frame in accordance with a first defined oscillation sequence.

72. A transformation processor according to claim 69, operable to divide the planar arrays into segments with reference to a set of segment co-ordinates associated with the planar array, each segment co-ordinate in the set of segment co-ordinates associated with a planar array.

73. A transformation processor according to claim 70, operable to redetermine each segment co-ordinate in the set of segment co-ordinates associated with each planar array from frame to frame in accordance with a first defined oscillation sequence.

74. A transformation processor according to claim 66, where the first defined oscillation sequence repeats after a predetermined number of iterations.

75. A transformation processor according to claim 66, where the first defined oscillation sequence is a function of the temporal locality.

76. A transformation processor according to claim 66, where the first defined oscillation sequence is a function of time as recorded by a time-measuring device.

77. A transformation processor according to claim 66, where the first defined oscillation sequence is a function of sequence pulses emitted by a sequencer.

78. A transformation processor according to claim 66, where the first defined oscillation sequence is a function of a pseudo-random generator.

79. A transformation processor according to claim 66, where the first defines oscillation sequence is a modulation function.

80. A transformation processor according to claim 66, where the difference in distance between reference points between frames having adjacent temporal localities is a single graphics information.

81. A transformation processor according to claim 65 operable to determine the orientation of reference points between frames having adjacent temporal localities at random.

82. A transformation processor according to claim 63, operable to derive the at least one attribute with reference to the position of the graphics information with the segment.

83. A transformation processor according to claim 63, operable to derive the at least one attribute by averaging the corresponding attribute values of at least two graphics information within the segment.

84. A transformation processor according to claim 63, operable to omit any segment having less than a predetermined number of graphics information for the purposes of deriving the at least one attribute.

85. A receiving terminal for use in a system for transforming graphics data, the receiving terminal operable to receive transformed graphics data created by a transformation processor according to claim 63, the receiving terminal operable to display each frame of the transformed graphics data moved in accordance with a second defined oscillation sequence.

86. A receiving terminal according to claim 85, operable to display each frame multiple times, each multiple display of the frame being moved in accordance with the second defined oscillation sequence.

87. A receiving terminal according to claim 85 operable to display frames in a predetermined alternating sequence.

88. A receiving terminal according to claim 85, where the second defined oscillation sequence repeats after a predetermined number of iterations.

89. A receiving terminal according to claim 85, where the second defined oscillation sequence is a function of the temporal locality.

90. A receiving terminal according to claim 85, where the second defined oscillation sequence is a function of time as recorded by a time-measuring device.

91. A receiving terminal according to claim 85, where the second defined oscillation sequence is a function of sequence pulses emitted by a sequencer.

92. A receiving terminal according to claim 85, where the second defined oscillation sequence is a function of a pseudo-random generator.

93. A receiving terminal according to claim 85, where the second defined oscillation sequence is a modulation function.

94. A receiving terminal for use in a system for transforming graphics data, the receiving terminal operable to receive transformed graphics data created by a transformation processor according to claim 69, the receiving terminal operable to display each frame of the transformed graphics data moved in accordance with a second defined oscillation sequence.

95. A receiving terminal according to claim 94, operable to display each frame multiple times, each multiple display of the frame being moved in accordance with the second defined oscillation sequence.

96. A receiving terminal according to claim 94 operable to display frames in a predetermined alternating sequence.

97. A receiving terminal according to claim 94, where the second defined oscillation sequence repeats after a predetermined number of iterations.

98. A receiving terminal according to claim 94, where the second defined oscillation sequence is a function of the temporal locality.

99. A receiving terminal according to claim 94, where the second defined oscillation sequence is a function of time as recorded by a time-measuring device.

100. A receiving terminal according to claim 94, where the second defined oscillation sequence is a function of sequence pulses emitted by a sequencer.

101. A receiving terminal according to claim 94, where the second defined oscillation sequence is a function of a pseudo-random generator.

102. A receiving terminal according to claim 94, where the second defined oscillation sequence is a modulation function.

103. A method of transforming graphics data into transformed graphics data, where the graphics data and transformed graphics data each comprise a set of frames, each frame in the set of frames comprising a temporal locality and an array of graphics information, the array having at least two dimensions and the graphics information having a set of attributes, where each frame of the transformed graphics data is created by the following method:
dividing the frame of graphics data having a corresponding temporal locality into segments, such that the segments so formed differ between frames having adjacent temporal localities;
dividing the frame of transformed graphics data into mapping segments, such that each mapping segment has at least one corresponding segment; and
for each segment, deriving at least one attribute from the set of attributes of at least one graphics information within the segment and including the derived at least one attribute in the set of attributes for each graphics information in its corresponding mapping segment.

104. A method according to claim 103, where the step of dividing the frame of graphics data into segments is achieved with reference to a reference point.

105. A method according to claim 104, including the step of redetermining the reference point from frame to frame in accordance with a first defined oscillation sequence.

106. A method according to claim 103, where the step of dividing the frame of graphics data into segments is achieved with reference to a set of segment co-ordinates.

107. A method according to claim 104, including the step of redetermining each segment co-ordinate in the set of segment co-ordinates in accordance with a first defined oscillation sequence.

108. A method of transforming graphics data into transformed graphics data, where the graphics data and transformed graphics data each comprise a set of frames, each frame in the set of frames comprising a temporal locality and an array of graphics information, the array having at least two dimensions and the graphics information having a set of attributes, where each frame of the transformed graphics data is created by the following method:
dividing the frame of graphics data having a corresponding temporal locality into a series of planar arrays, each planar array representative of at least one attribute from the set of attributes;
dividing each planar array into segments, such that the segments so formed differ between corresponding planar arrays of frames having adjacent temporal localities and differ between at least two of the planar arrays;
dividing the frame of transformed graphics data into mapping segments, such that each mapping segment has at least one corresponding segment from each planar array; and
for each segment in each planar array, deriving the at least one attribute represented by the planar array from at least one graphics information within the segment and including the derived at least one attribute in the set of attributes for each graphics information in the corresponding mapping segment for the planar array being processed.

109. A method according to claim 108, where the step of dividing each planar array into segments is achieved with reference to a set of reference points, each reference point in the set of reference points associated with a planar array.

110. A method according to claim 109, including the step of redetermining each reference point in the set of reference points in accordance with a first defined oscillation sequence.

111. A method according to claim 108, where the step of dividing each planar array into segments is achieved with reference to a set of segment co-ordinates, each set of segment co-ordinates in the set of segment co-ordinates associated with a planar array.

112. A method according to claim 111, including the step of redetermining each segment co-ordinate in the set of segment co-ordinates in accordance with a first defined oscillation sequence.

113. A method according to claim 105, where the first defined oscillation sequence repeats after a predetermined number of iterations.

114. A method according to claim 105, where the first defined oscillation sequence is a function of time as recorded by a time-measuring device.

115. A method according to claim 105, here the first defined oscillation sequence is a function of sequence pulses emitted by a sequencer.

116. A method according to claim 105, where the first defined oscillation sequence is a function of a pseudo-random generator.

117. A method according to claim 105, where the first defined oscillation sequence is a modulation function.

118. A method according to claim 103, including the step of redetermining the orientation of the reference point for the next frame at random.

119. A method according to claim 103, where the step of deriving the at least one attribute is determined with reference to the position of the graphics information within the segment.

120. A method according to claim 103, where the step of deriving the at least one attribute is determined by averaging the corresponding attribute values of at least two graphics information within the segment.

121. A method according to claim 103, including the step of omitting any segment having less than a predetermined number of graphics for the purposes of deriving the at least one attribute.

122. A method according to claim 103, including the step of displaying each frame of the transformed graphics data moved in accordance with a second defined oscillation sequence at a receiving terminal in receipt of the transformed graphics data.

123. A method according to claim 108, including the step of displaying each frame of the transformed graphics data moved in accordance with a second defined oscillation sequence at a receiving terminal in receipt of the transformed graphics data.

124. A method according to claim 122, where the step of displaying each frame is repeated a predetermined number of times, each repeat display of the frame being moved in accordance with the second defined oscillation sequence.

125. A method according to claim 122, where the step of displaying each frame is performed with reference to a predetermined alternating sequence.

126. A method according to claim 122, where the second defined oscillation sequence repeats after a predetermined number of iterations.

127. A method according to claim 122, where the second defined oscillation sequence is a function of the temporal locality.

128. A method according to claim 122, where the second defined oscillation sequence is a function of time as recorded by a time-measuring device.

129. A method according to claim 122, where the second defined oscillation sequence is a function of sequence pulses emitted by a sequencer.

130. A method according to claim 122, where the second defined oscillation sequence is a function of a pseudo-random generator.

131. A method according to claim 122, where the second defined oscillation sequence is a modulation function.

132. A method according to claim 103, including the step of directly deriving at least one attribute from the set of attributes for each graphics information in the transformed graphics data from the corresponding at least one attribute from the set of attributes for each graphics information in the graphics data.

133. A method according to claim 103, including the step of digitising a set of analogue images to create the graphics data.

134. A method according to claim 103, including the step of applying interlacing techniques to the transformed graphics data.

135. A computer-readable medium having software recorded thereon for transforming graphics data into transformed graphics data, the graphics data and transformed graphics data each comprising a set of frames, each frame in the set of frames comprising a temporal locality and an array of graphics information, the array having at least two dimensions and the graphics information having a set of attributes, the software including:
means for dividing a frame of graphics data into segments, such that the segments so formed differ between frames having adjacent temporal localities;
means for dividing a frame of transformed graphics data having a corresponding temporal locality into mapping segments, such that each mapping segment has at least one corresponding segment; and
means for deriving at least one attribute from the set of attributes for at least one graphics information within each segment and including the derived at least one attribute in the set of attributes for each graphics information in its corresponding mapping segment.

136. A computer-readable medium having software recorded thereon for transforming graphics data into transformed graphics data, the graphics data and transformed graphics data each comprising a set of frames, each frame in the set of frames comprising a temporal locality and an array of graphics information, the array having at least two dimensions and the graphics information having a set of attributes, the software including:
means for dividing the frame of graphics data having a corresponding temporal locality into a series of planar arrays, each planar array representative of at least one attribute from the set of attributes;
means for dividing each planar array into segments, such that the segments so formed differ between corresponding planar arrays of frames having adjacent temporal localities and differ between at least two of the planar arrays;
means for dividing the frame of transformed graphics data into mapping segments, such that each mapping segment has at least one corresponding segment from each planar array; and
for each segment in each planar array, means for deriving the at least one attribute represented by the planar array from at least one graphics information within the segment and including the derived at least one attribute in the set of attributes for each graphics information in the corresponding mapping segment for the planar array being processed.

137. Transformed graphics data derived from graphics data, where the graphics data and transformed graphics data each comprise a set of frames, each frame in the set of frames comprising a temporal locality and an array of graphics information, the array having at least two dimensions and the graphics information having a set of attributes, each frame of the transformed graphics data having been created by the following method:
dividing the frame of graphics data having a corresponding temporal locality into segments, such that the segments so formed differ between frames having adjacent temporal localities;
dividing the frame of transformed graphics data into mapping segments, such that each mapping segment has at least one corresponding segment; and
for each segment, deriving at least one attribute from the set of attributes of at least one graphics information within the segment and including the derived at least one attribute in the set of attributes for each graphics information in its corresponding mapping segment.

138. Transformed graphics data derived from graphics data, where the graphics data and transformed graphics data each comprise a set of frames, each frame in the set of frames comprising a temporal locality and an array of graphics information, the array having at least two dimensions and the graphics information having a set of attributes, each frame of the transformed graphics data having been created by the following method:
dividing the frame of graphics data having a corresponding temporal locality into a series of planar arrays, each planar array representative of at least one attribute from the set of attributes;
dividing each planar array into segments, such that the segments so formed differ between corresponding planar arrays of frames having adjacent temporal localities and differ between at least two of the planar arrays;
dividing the frame of transformed graphics data into mapping segments, such that each mapping segment has at least one corresponding segment from each planar array; and
for each segment in each planar array, deriving the at least one attribute represented by the planar array from at least one graphics information within the segment and including the derived at least one attribute in the set of attributes for each graphics information in the corresponding mapping segment for the planar array being processed.

139. A system for transforming graphics data according to claim 7, where the set of attributes includes a red colour intensity value, a green colour intensity value and a blue colour intensity value.

140. A system for transforming graphics data according to claim 7, where the set of attributes includes a hue value, a saturation value and a brightness value.

141. A system for transforming graphics data according to claim 7, where the set of attributes includes a luminance value, a B-Y colour difference value and a R-Y colour difference value.

142. A system for transforming graphics data according to claim 7, further including a digitiser, the digitiser operable to create graphics data from a set of analogue images.

143. A system for transforming graphics data according to claim 7, where the transformation processor adapts the transformed graphics data to include interlacing techniques.
